(19) United States
(12) Patent Application Publication
(10) Pub. No.: US 2018/0365324 A1
(43) Pub. Date: Dec. 20, 2018

(54) METHOD OF DATA ORGANIZATION AND DATA SEARCHING FOR USE IN CONSTRUCTING EVIDENCE-BASED BELIEFS

(71) Applicant: Considdr Inc., Boston, MA (US)

(72) Inventors: Noah Finberg, Boston, MA (US); Marcus Christiansen, Brookline, MA (US); Thomas Pietraho, Brunswick, ME (US)

(21) Appl. No.: 16/109,265

(22) Filed: Aug. 22, 2018

Related U.S. Application Data
(63) Continuation-in-part of application No. PCT/US2017/029053, filed on Apr. 24, 2017.
Application No. PCT/US2017/029053 is a continuation-in-part of application No. 15/557,486, filed on Sep. 12, 2017, now Pat. No. 10,083,240.

(51) Int. Cl. G06F 17/30; G06N 5/04

(52) U.S. Cl. CPC G06F 17/30719; G06F 17/30867; G06N 5/04; G06F 17/3069; G06F 17/30684

(57) ABSTRACT

A computer implemented method to develop well formulated evidenced-based belief, the beliefs being based on arguments and evidence that are associated with a given question.

### BACKGROUND INFORMATION

### Field of the Invention

The invention relates to computer-implemented methods of storing and organizing information to assist users in forming reasoned and well-informed beliefs using an interface such as a social media network or search engine.

### Discussion of Prior Art

Humans have very limited cognitive capacity, with the average individual's working memory being capable of processing approximately seven units of information at a time. In addition, without repetition and/or attempts to retain new information, it is theorized that the average human forgets approximately 40 percent of new information within nineteen minutes, 55 percent within one hour, and 75 percent within two days.

While a person's inability to process and retain new information is not new, this limitation has become a significantly greater issue in today's data and information driven world. In particular, this inability for humans to process and subsequently retain information makes it very difficult to develop well-formed and carefully deliberated beliefs. Instead, most people's opinions more closely resemble emotional convictions rather than informed and reasoned beliefs, and the few reasons that people pull from their memory to support those opinions are often little more than rationalizations for how they already feel.

Furthermore, when an individual deliberates about issues, the few thoughts that he or she recalls from long-term memory are systematically biased by affect. As a result, people tend to reject arguments and evidence that do not comport with their initial feelings regardless of how valid those arguments and evidence may be. In short, the average person is plagued by an uncontrollable, emotionally driven tendency to engage in motivated reasoning.

The format that information typically comes in, for example, articles, television segments, books, radio programming, etc., also makes it very difficult to be deliberative in forming beliefs, as people tend to read and listen passively—and there is no easy way to compare, contrast, and synthesize arguments made across different sources and even different mediums. As a result, the arguments and evidence to which individuals are exposed, and potentially store in memory, are arbitrary at best and systematically biased at worst. Modern technology, and the Internet in particular, exacerbate these problems by radically increasing the amount of information available on virtually any topic.

What is needed, therefore, is a method of organizing data, storing data, and searching that data in a manner that helps people consider arguments from all relevant perspectives and form beliefs rooted in evidence.

### BRIEF SUMMARY OF THE INVENTION

The invention is a computer implemented method that enables users to organize and store data in a format that enables the user to develop well-reasoned, evidence-based, beliefs, and, based on the format of data and user interactions, the method suggests influential arguments and evidence that may assist the user in improving his/her existing beliefs or in developing new beliefs.

More specifically, the method enables users to break down all types of information into a standard format that is based on questions and arguments, as well as support for the arguments, and stores that information in a user-accessible data store. The method enables the user to use that reformatted information to construct belief trees, which are structures for visualizing beliefs, and allows the user to continually update those beliefs with relevant information. Additionally, the method saves the reformatted data, and based on that formatted data the method generates suggested arguments that may assist a user in creating or developing a belief tree based on how influential certain questions, arguments, and evidence are to the other users of the method.

The method allows the user to easily collect and visualize an extraordinary amount of information in the form of questions and arguments, and provides a mechanism to assimilate this information into a well-reasoned and well-supported belief or sets of beliefs that are based on arguments. Additional questions and arguments may then be added to this initial set of arguments, allowing the user to assimilate new pieces of information, to consistently deliberate about issues of interest, and to continually help the user improve his/her existing beliefs.

The way the method stores the data, i.e. in associated objects comprising questions and arguments, enables the method to perform an intelligent search process referred to as logical aggregation, which allows the user to search for a topic or question of interest and receive a list of arguments that address that topic or question, with each argument containing its supporting evidence, which have been influential to other users in the social network.

Overall the method provides a mechanism for end-to-end information processing within a given interface. For example, the interface may be in the form a search engine that includes functions that allow users to create belief trees based on the questions and answers used with and discovered by the search engine. Or the interface may, for example, be in the form of a social network. With a social network, initially, a user is able to search for questions or topics of interest. The search may be performed on the internet in general, with relevant sources of information imported into the social networking system. Or, a user may search the social networking systems data store for questions and arguments that have been identified and imported by other users. In either example, the user interface allows the users to synthesize the data that their searches reveal, and then to format that data into a well-reasoned belief that is based on arguments.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 is a high level diagram illustrating the manner in which users interact with the method according to the invention.

FIG. 2 is a high level diagram illustrating the overall architecture.

FIG. 3 is a high level diagram that illustrates the process of using the overall system architecture to construct belief trees and to save those belief trees to a data store.

FIG. 4 is a flow chart that illustrates the process of constructing a belief tree.

FIG. 5A illustrates the Question Object.

FIG. 5B illustrates the Argument Object.

FIG. 5C illustrates the Question-Argument Object.

FIG. 5D illustrates the Merged-Question Object.

FIG. 5E illustrates the Merged-Argument Object.

FIG. 5F illustrates the Work Object.

FIG. 6 is a flow chart that illustrates a first method of merging objects.

FIG. 7 is a flow chart illustrating the details of the merger of question objects.

FIG. 8 is a flow chart that illustrates the second embodiment of the method of merging objects.

FIG. 9 is a flow chart that illustrates the second method of merging question objects.

FIG. 10 if a flow chart that illustrates the second method of merging questionargument objects.

FIG. 11 is a flow chart that illustrates the manner in which relevance measures are incremented during the second method of merging objects.

FIG. 12 the first embodiment of the logical aggregation search process.

FIG. 13 is a flow charge that illustrates the Question-Argument suggestion method.

FIG. 14 illustrates a manual method of inputting material into the data store.

FIG. 15 is a flow chart illustrating an automated method of scraping information from the internet for use with the method.

FIG. 16 is a flow chart illustrating an automated method of scraping information from PDF documents for use with the method.

FIG. 17 is a high-level block diagram illustrating the exchange of information and creation of user beliefs in a social networking system.

FIG. 18 is an example user interface page illustrating a user's workspace within the social network.

FIG. 19 is an example social network interface page illustrating the Question-Argument creation process.

FIG. 20 is an example graphical social network interface illustrating a basic belief tree.

FIG. 21 is an illustration of example social network belief tree construction page before any questions have been added.

FIG. 22 is an example social network belief tree construction interface page showing a tree having questions added.

FIG. 23 illustrates the example social network belief tree creation interface page showing a pro/con table.

FIG. 24 illustrates an example logical aggregation search result interface page in the social network.

FIG. 25 illustrates an example of the second user interface which is a search engine with a belief tree construction window.

FIG. 26 illustrates the second embodiment of logical aggregation.

FIG. 27 illustrates the manner of calculating probabilities within the second embodiment of logical aggregation.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

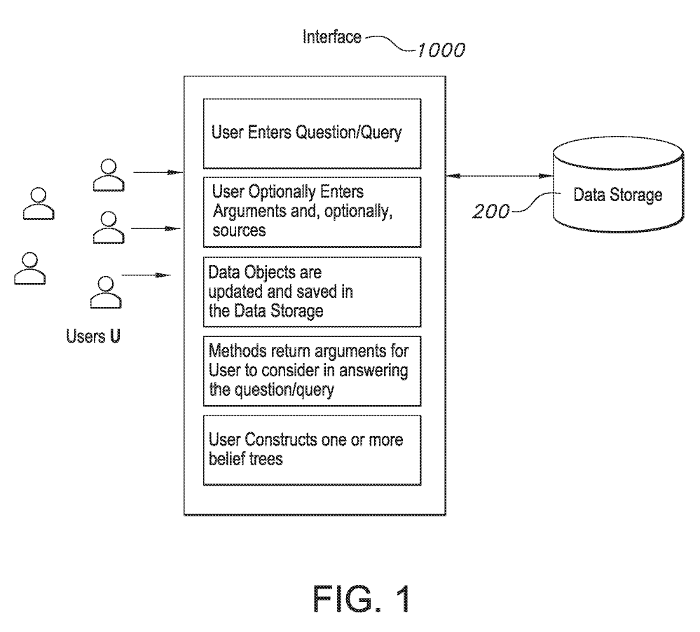

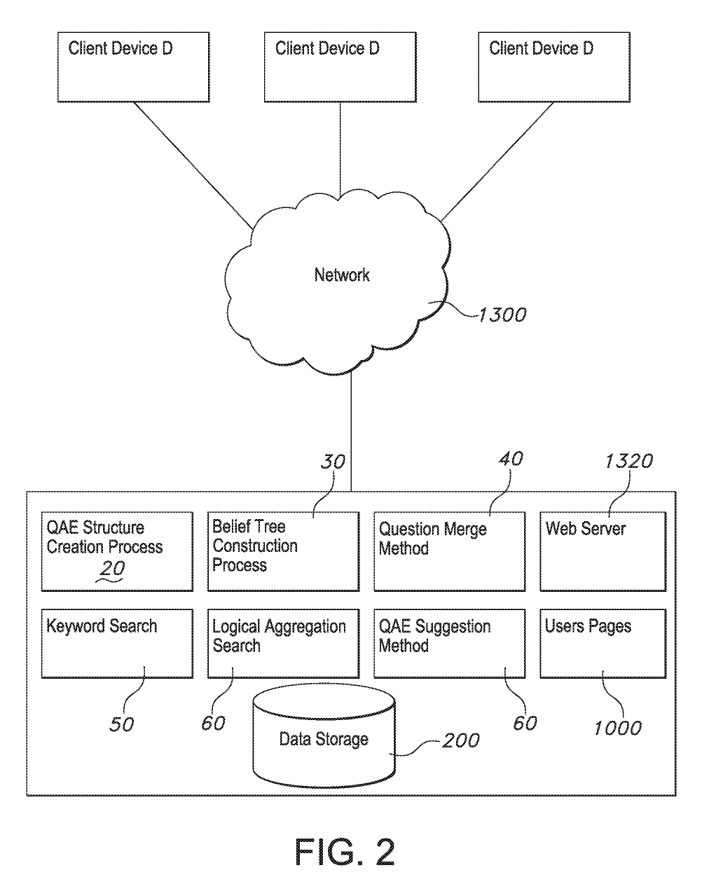

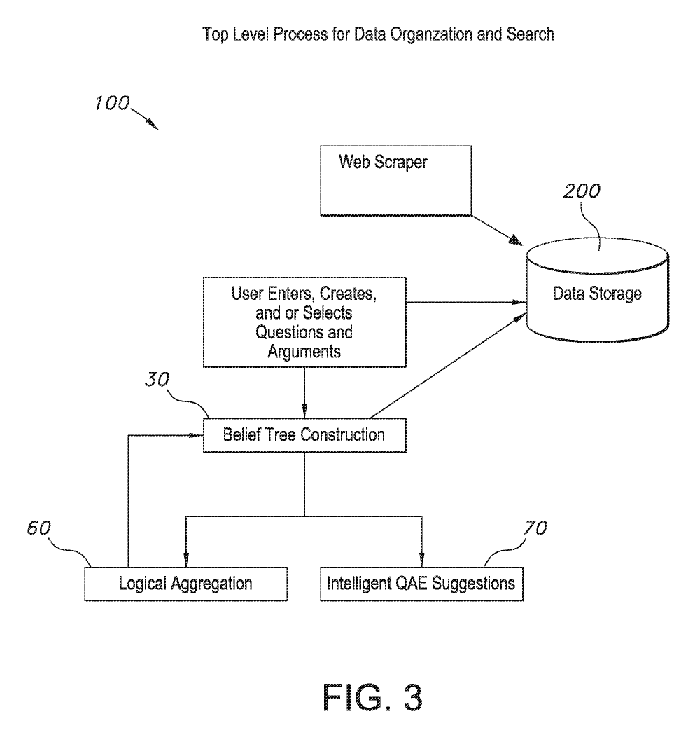

FIGS. 1-5 illustrate a computer-implemented method 100 for gathering and organizing data to enable searching of that data in a manner that enables users to develop find relevant information and arguments that assist the user in forming well-informed evidence-based beliefs. The method 100 provides, populates, and uses a database 200 that contains a plurality of data objects, including, among other objects, question objects 12 and argument objects 14, and that allows users to interact with the database 200 to identify relevant information, i.e. argument objects, that are used to construct belief trees 30. In general, belief trees 30 are collections of supported arguments that address a particular question, idea, or belief. An interface 1000, such as a social network 1100 or a search engine 1200, is provided to enable a user to interact with the database 200 by entering search terms, i.e. question objects 12, and consider the search results, i.e. argument objects 14, in order to construct the belief trees 30. The database 200 may be populated by users through a method of manual data entry, enabled by the interface 1000, and/or filled by an automated scraping process 300 that searches the internet for useful information, i.e. arguments, as further defined below. This description generally refers to the search terms as a “question”, however, it is understood that the search terms need not necessarily be in the form of a proper question and may simply be, for example, key words that are of interest to a user.

As users interact with the interface 1000 the question objects 12 become associated with any number of argument objects 14, and the argument objects 14 become associated with any number of question objects 12. These associations enable the method 100 to identify question objects 12 that are similar to one another, to identify argument objects 14 that are similar to one another, and to identify questions and arguments that have some relevance to one another and may be particularly relevant to a given user of the method 100. These similarity and relevancy measures enable a number of search methods that identify argument objects 14 that may be relevant to user entered questions, thus enabling the method 100 to provide more pertinent search results, i.e. potentially relevant argument objects 14, in response to those user queries.

More specifically, as a user enters questions, queries, and/or key words into the interface 1000 the search methods return suggested argument objects 14 that may be useful in answering or contemplating the question. The user is then able to consider each of these suggested argument objects 14 within the interface 1000 and add those that the user feels are most pertinent or relevant in addressing a topic to a belief tree 30. Over time, the user is able to use the interface 1000 to develop well informed evidence based beliefs that he/she may refer back to and/or continue to refine. As a result, the belief trees 30 are always rooted in substance and users are not left to rely on their memories and emotions when forming beliefs.

FIGS. 1-4 illustrate high-level block diagrams of the process of entering, finding and considering question objects 12 and argument objects 14 and for forming belief trees 30, showing the topology of the software architecture, the sub-methods within the software architecture, and the relationship between those sub-methods. In particular, the illustrations show the process creating and associating Question Objects 12 and Argument Objects 14, populating a data store 200 with the data from the Question Objects 12 and Arguments Objects 14, creating belief trees 30, and generating logical aggregation search results 60/700 and QA suggestions 70 based on the Question Object and Argument Object data in the data store 200. The data store 200 may be any suitable medium for storing data, such as a relational database.

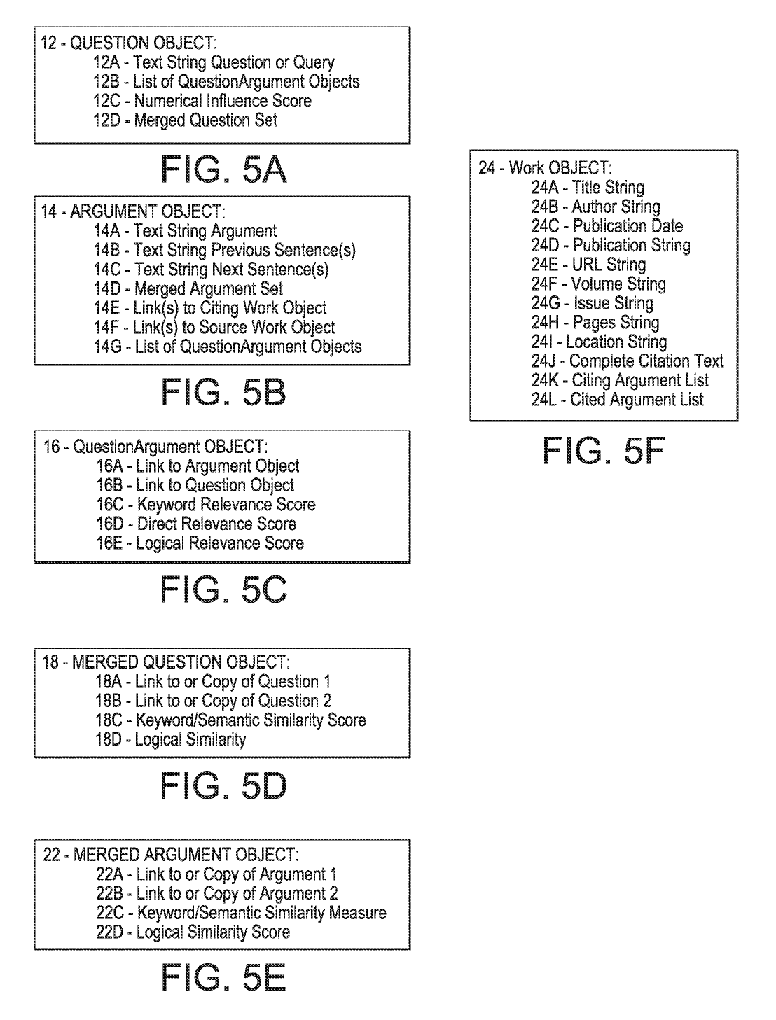

FIGS. 5A-5F illustrate the data objects 12, 14, 16, 18, 22, and 24 that are stored in the database 200 and used by the method 100. The question object 12 has a text string 12a that includes the query entered by the user, a list 12b of QuestionArgument objects 16, and an optional influence score 12c that measures how influential the question 12 is and that is initially set to 0 to indicate that it has not yet been influential. The question object 12 also includes a set or list 12d of merged question objects 18. The merged question objects 18, illustrated in FIG. 5D contain question links or copies 18a, 18b, to a first question object 12 and a second question object 12 that have been merged together into a single structure, such as a belief tree 30, along with a keyword similarity measure 18c that measures how similar the text strings 12a of two question objects 12 are to one another and a logical similarity measure 18D that calculates how logically relevant the two questions are to one another according to the methods defined below.

The argument object 14 has a text string containing the argument 14a, a pair of context strings or lists 14b, 14c, which may be manual quotes/statements entered by the user or they may be sentences that are adjacent to the argument 14 that are found in a work if created by the scraping method 300. The argument object 14 also has a set of merged argument objects 14d that may contain a number of merged argument objects 22. The merged argument objects 22 are similar in structure to the merged question objects 18 and contain argument links 22a, 22b to the argument objects 14 that have been merged, a keyword similarity measure 22c, and a logical similarity score 22d that tracks the number of times the two argument objects 14 have been merged. The argument objects 14 also includes a link 14E to a citing work object 24 and a link 14F to a source work object 24, if any, where the citing work is a primary document or web source identified by a scraping method 300 and the source work is a second document that is cited by, quoted, or referenced by the citing work. The work objects 24 are illustrated in FIG. 5F and the citing work objects, source work objects, and scraping method 300 are described in more detail below. The argument object 14 also includes a list 14G of all QuestionArgument Objects 16 that it has been associated with.

The QuestionArgument Objects 16 are created when an argument 14 is merged with a question 12. For example, after the user enters a question into an interface 1000 a number of argument objects 14 are presented to the user in the interface 1000. The user reviews these argument objects, and adds those s/he feels are relevant to a belief tree 30. The process of adding an argument object 14 to a belief tree 30 causes the method 100 to create a new QuestionArgument object 16 for that question object 12 and the argument object 14. The QuestionArgument Objects 16 contain a link 16A to the argument object 14, a link 16B to the question object 12, a keyword relevance score 16C, a direct relevance score 16D, and a logical relevance score 16E. The objects 12, 14, 16, 18, 22 and 24 are saved to the data store 200.

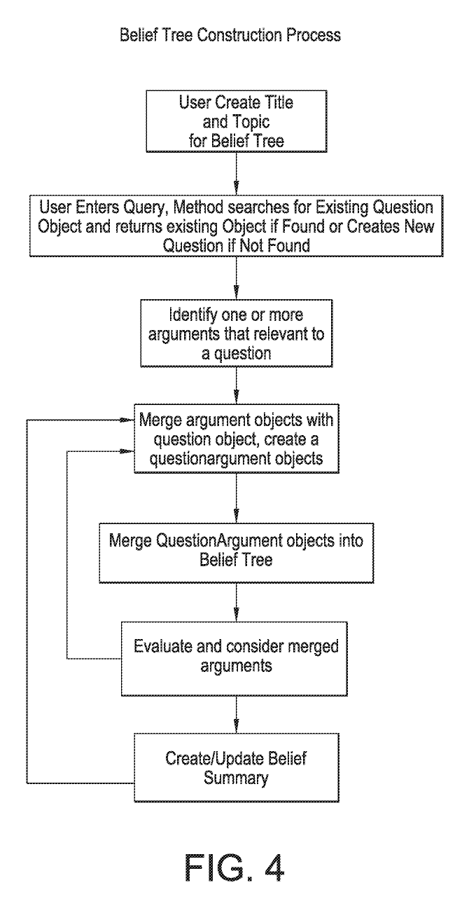

FIG. 4 is a block diagram that illustrates the belief tree construction process. The user first adds one or more questions 12 that she/he wishes to answer, address or contemplate in the belief tree 30. Again, in this sense the term “question” is intended to be construed broadly, and the user may use topics or key words that are not necessarily in the form of a traditional question. Depending on the interface 1000, users may add questions 12 to belief trees and then add arguments 14 to the questions 12 in the belief tree 30, or the interface may return a list of arguments 14 that the user adds directly to the belief tree.

Upon the user entering a question or query, the method 100 first searches the database 200 for a similar question object 12 by performing a keyword similarity search of the text entered in the query and the text sting 12a of the question objects 12 in the data base 200. The keyword similarity test is performed using conventional software coding techniques as there are several suitable known techniques and methods for performing this type of search. For example, MYSQL is a common open-source relational database management system that provides keyword search utilities. Additionally, there are several known open-source keyword search engines such as LUCENE and SPHIX. If the keyword similarity test reveals a match, i.e. the same question text belongs to an existing question object, then the existing question object 12 is updated, i.e. its influence score and merged question sets are updated, and used with this belief tree 30. If no question object 12 exists that has a similar text string 12a as the text of the entered question then a new question object 12 is created and used for this belief tree 30.

The method 100 then searches the database 200 for potentially relevant argument objects 14 and present a list to the user in the interface 1000. The user then finds one or more argument objects 14 that address the question 12 or questions 12 in the belief tree 30 and adds the argument object 14 to the belief tree 30. Merging the arguments 14 into the belief tree 30, having the question object 12, merges the objects 12, 14, 16, 18, 22, as described below, and increments that question objects 12 influence score 12c. The arguments 14 that have been merged are displayed in the belief tree creation window.

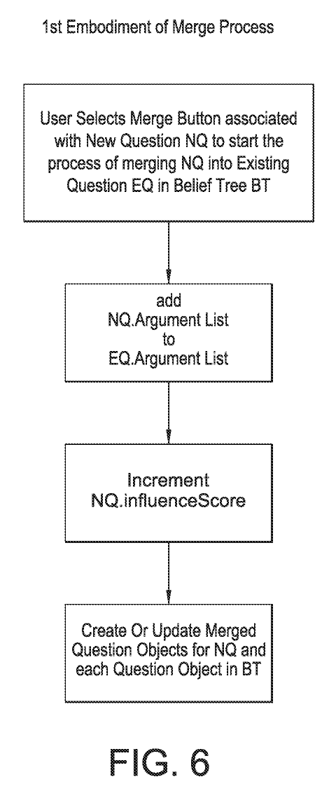

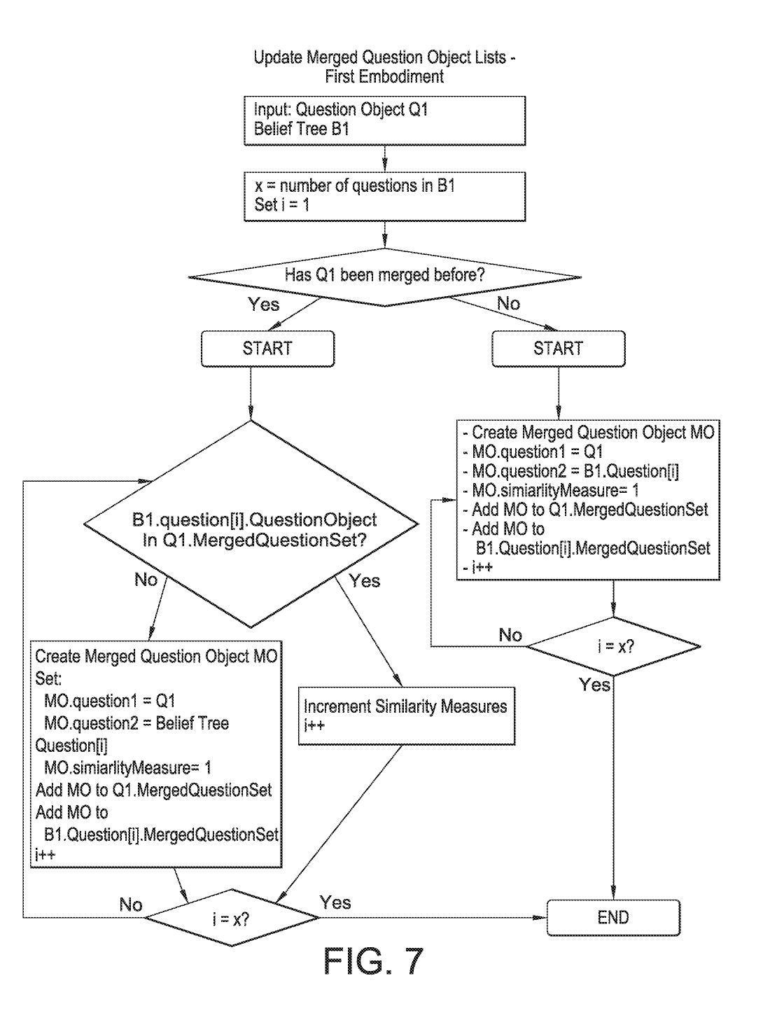

FIGS. 6 and 7 are block diagrams that illustrate a first embodiment of the merge method 40. The merge method 40 adds the data associated with a new question 42 to an existing question 44 in a belief tree 30 and increments the new question's 42 influence score. More specifically, the new question 42 is a question object 12 that is being created by a user and saved in the data store 200 as a part of an existing belief tree 30, the new question having a string 42a that is the user entered query, a question argument object list 42b that contains the argument objects 14 being added to the belief tree 30, influence score 42c, and a merged question set 42d. The existing question 44 is a question object 12 that the user had previously added to the belief tree 30 and has a string 44a, a question argument object list 44b, influence score 44c, and a merged question set 44d. The merge method 40 adds the argument objects 42b from the new question 42 to the existing question's 44 argument object list 44b.

The merge method 40 also updates the merged question sets 42d, 44d, for the new question 42 and the existing question 44, as well as for each question object 12 that had previously been merged with the existing question object 44. A question object 12 having a merged question set 12d that is empty indicates that the question object 12 has not previously been merged with other question objects 12. If the new question 42 has an empty merged question set 42d the merge method 40 creates new merged question objects 18 for the new question object 42 and the existing question object 44, and for the new question object 42 and each other question object 12 that had previously been merged with the existing question object 44. For example, if the existing question object 44 had been merged with 3 other question objects 12, a total of 4 merged question objects 18 are created, one merged question object 18 for each new pair of question objects 12 that are being merged for the first time. In each instance, the merged question object 18 has links 18a, 18b to the two question objects 12 that are being merged, i.e. new question object 42 and existing question object 44, and the question similarity measure 18c that is initially set to 1. A link to, or copy of, the merged question object 18 is added to the merged question set 12d for each question object 12 that was merged, i.e. new question object 42 and existing question object 44.

If the new question's 42 merged question set 12d is not empty the merge method 40 iterates through the new question's 42 set of merged question objects 42d to determine whether a merged question object 18 exists for the existing question 44 and/or any of the question objects 12 in the existing question object's 44 merged question set 44d, i.e. the method 40 checks if existing question 44 is included as either the first merged question object 18a or the second merged question object 18b in a merged question object 18. If a merged question object 18 does exist for a pair of the question objects 12 its similarity measure 18c is incremented, for example, by one. If a merged question object 18 does not exist for a pair of question objects 12 a new object 18 is created with links 18a, 18b to the two question objects 12 and the similarity measure 18c is set to 1. The new merged question object 18 is added to each question objects 12 set of merged questions 12d. Merging the question 12 into another question and/or into a belief tree 30 also increments the question objects 12 influence score 12c by, for example, one.

Users may also merge argument objects 14 through a process similar to the question object merge method 40. For example, as the user reviews the arguments 14 associated with a question 12 in a belief tree 30, she/he may decide that some are similar and therefore not needed on their own. The user may drag one argument 14 on to the other argument 14 and the method 100 merges the two argument objects 14, 14 into a merged argument object 22. The merged argument object 22 has links, 22a, 22b, to the two argument objects 14 that are merged and an argument similarity measure 22c that counts the number of time two argument objects are merged. Only the original argument remains visible in the belief tree 30. If the argument objects 14 have been merged before the argument similarity measure 22c is incremented. If the argument objects 14 have not been merged before a new merged argument object 22 is created containing links 22a, 22b, to the two argument objects 14 and an argument similarity measure 22c that is initially set to 1. The merged argument object 22 is added to each argument object's 14 merged argument set 14d.

Once the user feels as though she/he has added enough Question Objects 12 and Argument Objects 14 to the belief tree 30 she/he considers all of the arguments and enters a belief summary 32 in the interface.

For example, from the interface the user may search for the questions or keywords such as “are Americans politically polarized?” and the method 100 may return a number of Question Objects 12 and Argument Objects 14, such as 1) Question: are Americans polarized?; Argument: Politically engaged Americans increasingly take ideologically consistent positions; evidence: quotes and charts from an article published by the Pew Research Centers; and 2) Question: Are Americans becoming more polarized?; Argument: members of different parties have become increasingly ideologically distinct;

The user considers each Question 12 and the underlying Arguments 14, and, after finding the Question 12 and/or Argument 14 persuasive or, at least, relevant, uses the interface 1000 to add the objects associated with the Question Objects 12 and Argument Objects to the belief tree 30, thus causing the merger of objects as previously explained. Using the previous political polarization example, a user may create a belief summary 32 such as “Democrats and Republicans continue to grow apart. Democrats are much more likely to identify as liberal and Republicans more conservative than they were in the past. Members of both parties have also become much more ideologically consistent in issue positions that they take—this is especially true for those who participate in politics the most.”

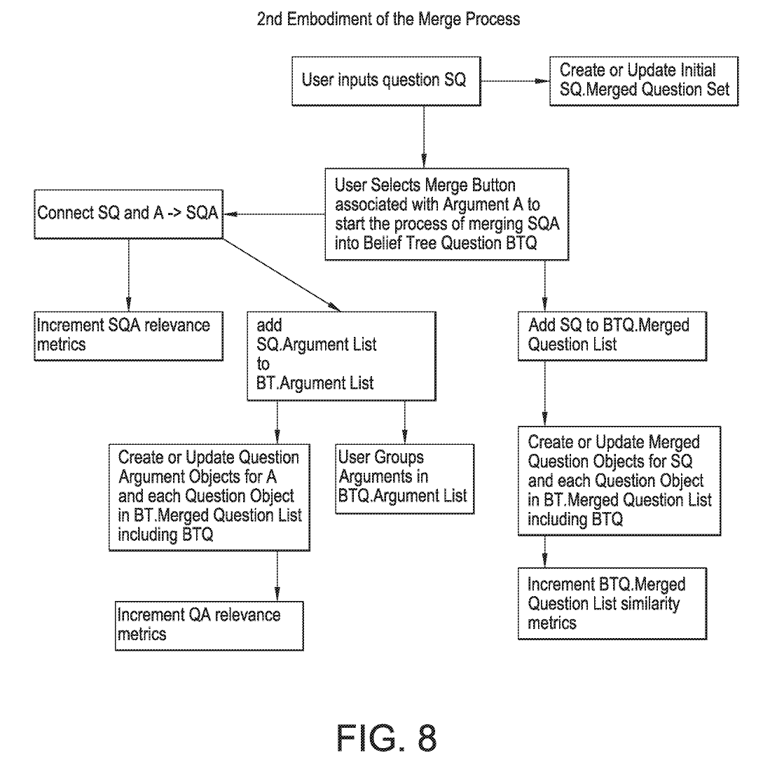

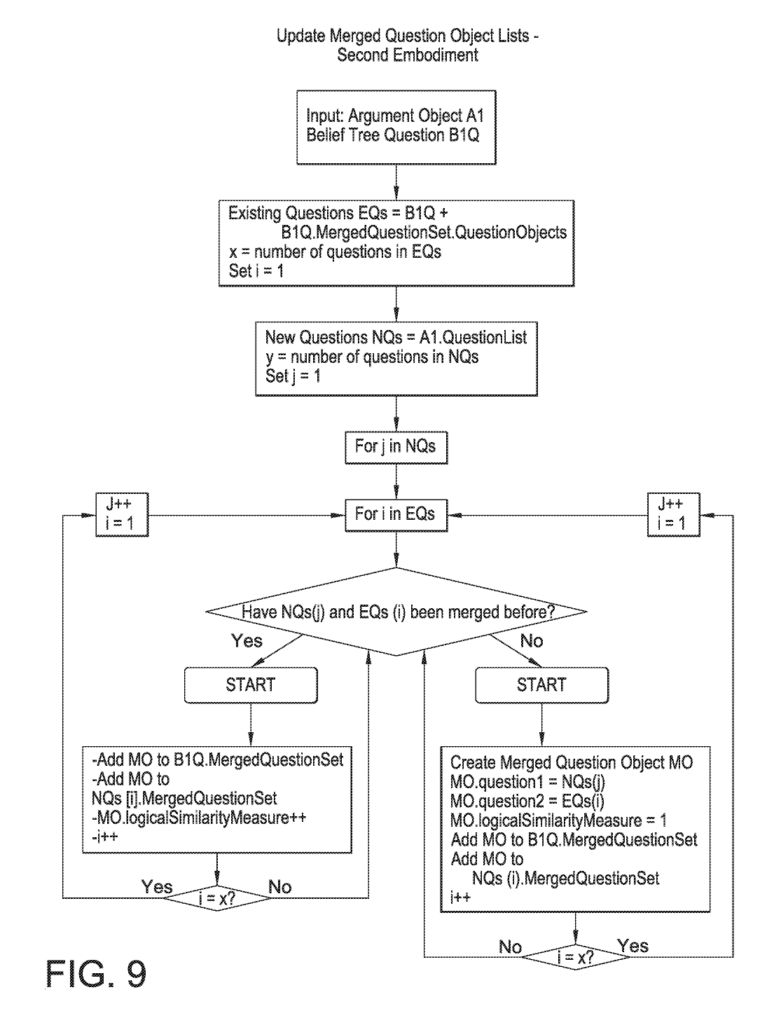

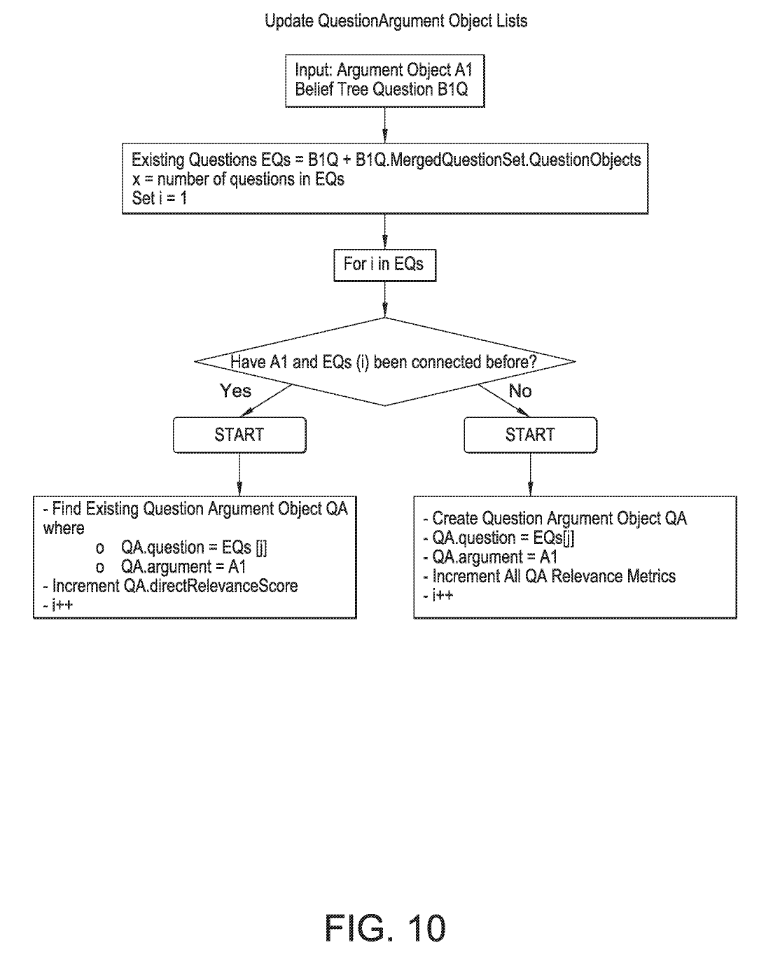

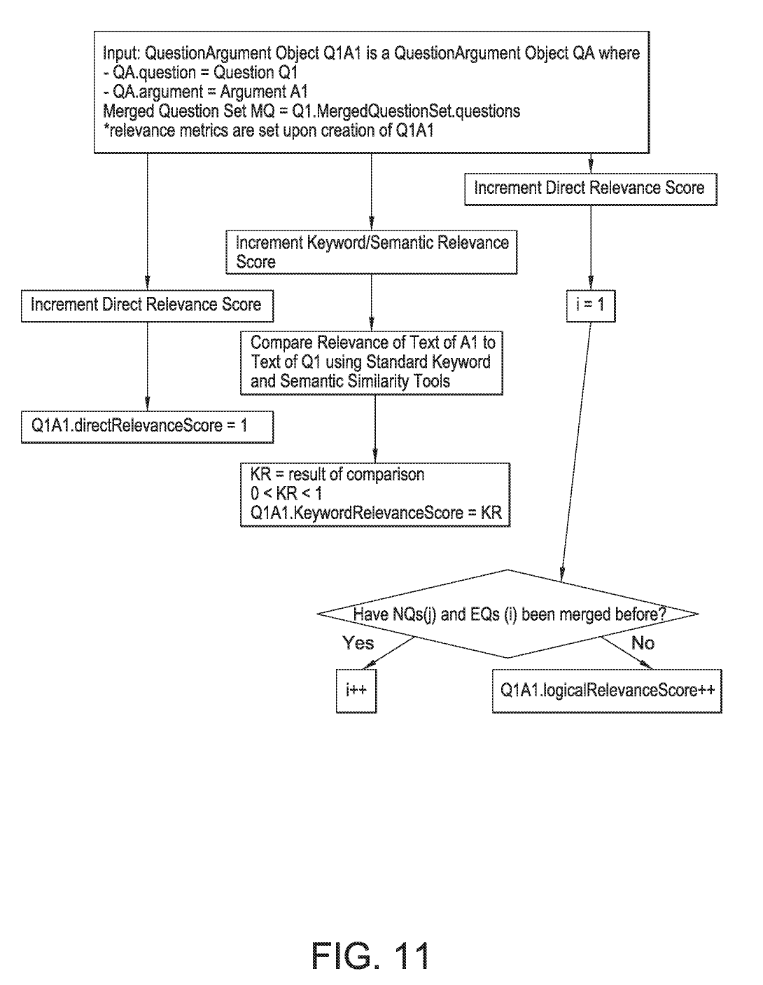

FIGS. 8-11 illustrate the second embodiment of the merging process 400 whereby a question 12 and argument 14 are merged together in a belief tree 30. Again, as described above, each time a user enter a question 12 for searching in the interface 1000, the method 400 performs a keyword search of the datastore 200 to determine whether the exact query is associated with an existing Question object 12. If no question object exists for the query a new Question object 12 is created using the text of that query, or the existing question object 12 is used for this merger method 400 and it merged question set is updated to indicate this newly entered question is being merged with an existing question.

When a user adds an Argument 14 to a Belief Tree 30 for a given question 12, the method 400 checks to see if a QuestionArgument Object 16 exists for the Question Object 12 and Argument Object 14. If no QuestionArgument Object 16 exists the method 400 creates a QuestionArgument object 16 with a link 16A to the Argument Object 14 and a link 16B to the Question Object 12. Otherwise, the method 400 updates the existing QuestionArgument Object 16. Each QuestionArgument object 16 also includes three relevance scores: A Keyword Relevance Score 16C, a Direct Relevance Score 16D, and a Logical Relevance Score 16E.

For example, suppose the user searches the query “self-driving cars safety concerns.” The system then finds or creates a Question object (Q1) 12 with the text of Q1 12A containing that query. In creating her Belief Tree 30, the user adds the Argument (A1) 14 “Almost 80 percent of Americans fear traveling in a self-driving car, a recent poll found.” from the search results. The system then checks to see if a QuestionArgument Object exists for the Question Object 12 and Argument Object 14 and if not it creates a Question Argument object QA1 16 with a link 16A to A1 and a link 16B to Q1 with new relevance measures 16C, 16D, 16E. If a QuestionArgument Object 16 does exist for Q1 and A1 the relevance measures 16C, 16D, and 16E are updated.

The keyword relevance score 16C is calculated using conventional approaches for measuring the relationships between two strings of text 12A, 14A. This may include both measuring the semantic similarity between strings of text with semantic approaches such as Latent Semantic Analysis or keyword approaches such as n-gram analysis. These scores are typically normalized between 0 and 1.

The direct relevance score 16D is calculated by counting the frequency with which the same Question 12 and Argument 14 are linked directly together in a QuestionArgument object 16. Upon creation of the QuestionArgument Object its direct relevance score 16D is set to 1 and each time the QuestionArgument Object 16 is updated thereafter the direct relevance score 16D is incremented.

Logical relevance 16E between an Argument 14 and a Question 12 is calculated using a Question object's 12 Merged Question Set 12D and is determined by calculating the number of shared Arguments 14 between a Question 12 and its similar Questions 12 linked through its Merged Question Set 12D. A Question 12 Q1 is deemed to be similar to a Question 12 Q2 if it has there is a merged question object 18 having a combination of keyword similarity 18C and logical similarity 18D scores above a predefined threshold. Suppose Q2 is similar to Q1 through its Merged Question Set 12D, i.e. there exists a merged question object 18 in the merged question set 12D having a link 18A to Q1 and a link 18B to Q2, and having a logical similarity score 18D of 0.5 and keyword similarity score 18C of 0.2 and that the threshold is set a 0.6, Q2 would be sufficiently similar to Q1 because it has a total similarity of 0.7.

For example, assume QA1 has links to Q1 and A1. If a QuestionArgument Object 16 exists that links Q2 and A1, then A1 has also been directly connected to Q2. Therefore, A1 is more logically relevant to Q1 because it was also directly relevant to Q1's similar Question, i.e., Q2. Each similar question to Q1 that has been directly connected to A1 increments the logical relevance score between Q1 and A1 optionally weighted by the magnitude of similarity between Question objects 16E. In the example above, the logical relevance score 16E on the QuestionArgument Object 16 QA1 would be incremented by 0.7.

Users may merge Arguments Objects 14 and/or Question Objects 12 together in their Belief Trees 30 by grouping them together in the interface 1000. The interface 1000 functionality is created using conventional programming methods. When a user decides A1 and a second Argument Object 14 A2 are sufficiently similar to group together, the method 100 creates a Merged Argument Object 22 linking A1 22A and A2 22B if it does not already exist. Similarly, adding an Argument Object 14 to a belief tree 30 merges the question objects 12 that the argument 14 addresses to the belief tree as well, thereby causing a merger of question objects within the belief tree 30 in a merged question object 18.

The strength of this similarity between Argument Objects 14 A1 and A2 is stored in two measures on the Merged Argument Object 22: Keyword/Semantic Similarity 22C and Logical Similarity 22D. Likewise, each time a Merged Question Object 18 is created, the system calculates a Keyword/Semantic Similarity Score 18C as well as a Logical Similarity Score 18D to measure the similarity between two Question Objects 12.

The keyword relevance scores 18C, 22C are calculated using standard approaches for measuring the relationships between two strings of text. This may include both measuring the semantic similarity between strings of text with semantic approaches like Latent Semantic Analysis or keyword approaches like n-gram analysis. These scores are typically normalized between 0 and 1. For example, the Merged Argument Object's Keyword/Semantic Similarity may be calculated by comparing both linked Arguments' Text String 14A.

The Merged Question Objects 18 logical similarity score 18D may be determined in a number of ways. One manner of calculating the logical similarity score 18D is by counting the number of shared Argument objects 14 in a Merged Question Object's 18 linked Questions' (Q1 and Q2) QuestionArgument List 12B. For example, let Q1 include Arguments A1, A2, and A3 in its QuestionArgument List. Let Q2 include Arguments A1, A4, and A5. In this case, the system would increment the Merged Question Object's logical similarity by one because both Questions share one Argument (A1) in their Argument Lists as Q1 and Q2 are considered to be more logically connected because the same Argument A1 was relevant to both Questions Q1, Q2. Merged Argument Objects 22 logical similarity scores 22D may be calculated in a similar manner but relying on the number of shared question objects between merged argument objects.

Alternatively, the logical similarity scores 18D, 22D, may be calculated as follows. As explained before, when a user connects an argument object 14 (A) and a question object 12 (Q) in the course of belief tree construction 30, the method 100 creates or updates a QuestionArgument (QA) object 16 which links Q to A. The QuestionArgument object also keeps track of the frequency with which A has been directly connected to Q in its Logical Relevance Score 16D.

Connecting many arguments with the same Question qᵢ with varying frequencies produces a probability distribution p(qᵢ) that indicates the degree of similarity between question objects 12. For any Argument Object aⱼ connected to qi, the probability that aⱼ was connected to qᵢ is equal to the number of times (Nₐⱼ) aⱼ was connected to qi divided by the total number of times (N) all Arguments (aⱼ . . . aₙ) were connected to qᵢ.

For an example, assume that four arguments have been connected with q₁; a1 two times, a2 three times, a3 one time, and a4 four times, where N=10. This produces the following QuestionArgument probability distribution.

Just as qᵢ has a probability distribution, any other question qₖ does as well. Thus, in order to measure the difference or “distance” between these two questions, the divergence between the two question's probability distributions is measured. In order to do so, the Kullback-Leibler Divergence D_{KL}(p(q)μp(qₖ)) is used. The Kullback-Leibler Divergence adapted for this method is defined below:

$${D}_{KL} ( p ( {q}_{i} ) \vert \vert p ( {q}_{k} ) ) = {\sum }_{n} p ( {q}_{i} ) ( n ) ln \frac{p ( {q}_{i} ) ( n )}{p ( {q}_{k} ) ( n )}$$

Where: p(qᵢ) is question qᵢ's probability distribution; p(qₖ) is question qₖ's probability distribution; and n is the total number of arguments in the dataset.

The Kullback-Leibler Divergence produces a positive number between 0 and 1. A divergence value of 0 indicates that a similar, or exactly the same, behavior is expected of the two probability distributions, where a divergence of 1 indicates that the behavior of the two distributions is so different that the expectation given the first distribution approaches zero.

As the Kullback-Leibler Divergence is a measure of difference and the method 700 measures the similarity between questions, the Kullback-Leibler Divergence value is subtracted from 1. Therefore, the Merged Question Objects Logical Similarity (LS) 18D is defined as the following:

LS(qᵢ, qₖ)=1−D_{KL}(p(qᵢ), p(qₖ))

Similarly, when a user connects an Argument Object 14 (A) and a Question Object 12 (Q) in the course of Belief Tree 30 construction, the method 100 creates or updates a QuestionArgument 16 (QA) Object which links Q to A. This QuestionArgument 16 object also keeps track of the frequency with which A has been directly connected to Q.

Connecting many Questions 12 with the same Argument 14 aᵢ with varying frequencies produces a probability distribution p(aᵢ). For any Question Object 12 qⱼ connected to aᵢ, the probability that qⱼ was connected to aᵢ is equal to the number of times (N_{qj}) qⱼ was connected to aᵢ divided by the total number of times (N) all Questions (qⱼ . . . qₙ) were connected to aᵢ.

For an example, assume that four questions have been connected with ai: q1 two times, q2 three times, q3 one time and q4 four times, where N=10. This produces the following QuestionArgument probability distribution:

Just as aᵢ has a probability distribution, any other argument aₖ does as well. Thus, in order to measure the difference or “distance” between these two arguments, the divergence between the two arguments' probability distributions is measured. In order to do so, the Kullback-Leibler Divergence is used. The Kullback-Leibler Divergence adapted for this problem is defined below:

$${D}_{KL} ( p ( {a}_{i} ) \vert \vert p ( {a}_{k} ) ) = {\sum }_{n} p ( {a}_{i} ) ( n ) ln \frac{p ( {a}_{i} ) ( n )}{p ( {a}_{k} ) ( n )} \qquad$$

Where: p(aᵢ) is argument aᵢ's probability distribution; p(aₖ) is argument aₖ's probability distribution; and n is the total number of questions in the dataset.

Again, the Kullback-Leibler Divergence produces a positive number between 0 and 1. A divergence value of 0 indicates that a similar, or exactly the same, behavior is expected of the two probability distributions, where a divergence of 1 indicates that the behavior of the two distributions is so different that the expectation given the first distribution approaches zero.

As the Kullback-Leibler Divergence is a measure of difference and the method 700 measures the similarity between arguments, the Kullback-Leibler Divergence value is subtracted from 1. Therefore, the Merged Argument Objects Logical Similarity (LS) 22D is defined as the following:

LS(aᵢ, aₖ)=1−D_{KL}(p(aᵢ), p(aₖ))

As previously noted, having a data store 200 containing the objects 10, and belief trees 30 enables a number of search and suggestion methods.

The first search and suggestion method is a keyword search 50 of the information in the data store 200, and in particular the question objects 12 text string 12a and the arguments objects 14 argument text string 14a. When a user enters search terms into the interface 1000 the keyword search 50 lists similar question objects 12 and argument objects 14 that are in the data store 200 based on similar keywords. There are several suitable known techniques and methods for performing this type of search. For example, MYSQL is a common open-source relational database management system that provides keyword search utilities. Additionally, there are several known open-source keyword search engines such as LUCENE and SPHIX.

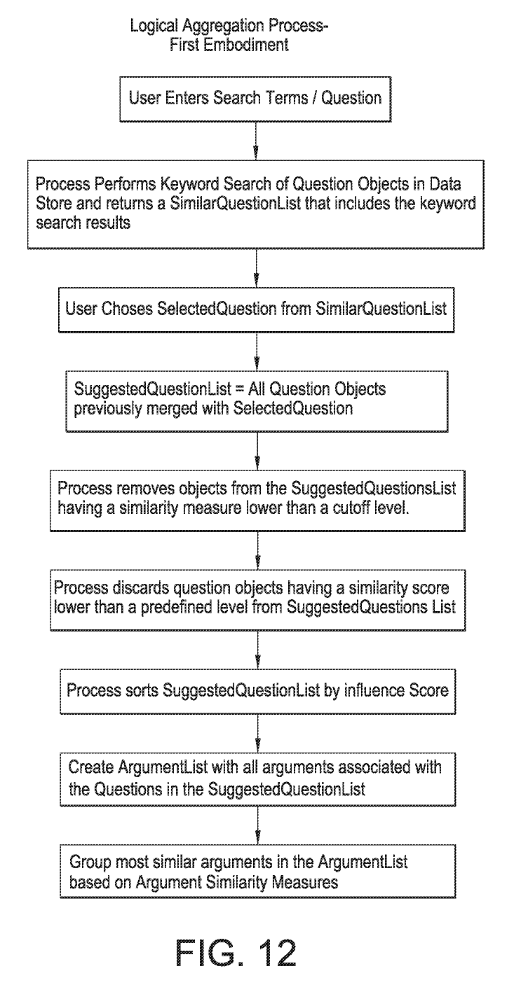

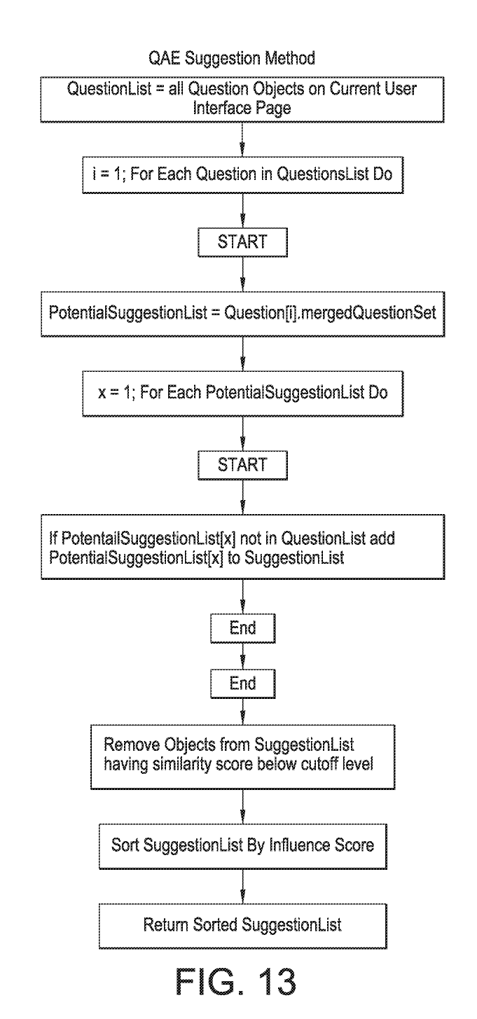

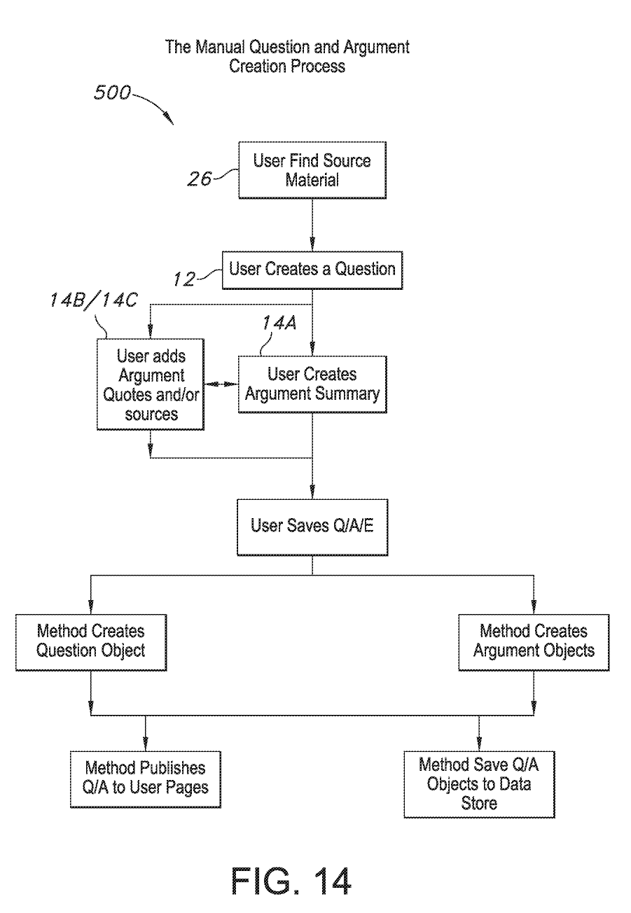

The second type of search and suggestion is the first embodiment of logical aggregation 60, which is illustrated by the block diagram in FIG. 12. In response to a user's search request logical aggregation 60 uses the structure of the data in the data store 200 to identify similar question objects 12 that have been influential to other users, and returns argument objects 14 that are likely to be relevant and influential in answering the question that is being searched.

More specifically, a user enters a question or search terms into a search window on a user page 100, and the logical aggregation method 60 creates a similar question list 62 by performing a keyword search of the question objects 12 text strings 12a that are in the data store 200. The user reviews the similar question list 62 in the search results window and chooses a selected question 63 that is a question object 12 from the list 62 that appears relevant or interesting. The method 60 then creates a suggested question list 64 having all the question objects that the selected question object 63 has been merged with, i.e. those found in the merged question list 63d, 22d.

The method 60 sorts the suggested question list 64 using the merged question objects' 18 similarity measures 18c and influence score 12c. In one embodiment, the method 60 first removes all question objects 12 having a similarity measure 12c that are below a cutoff level 67 from the suggested question list 64. The cutoff level 67 may be defined in a number of ways. For example, the cutoff level may be set to reject the lowest 25% of similar questions. Or, it may be set based on the number of similar questions, i.e. it may reject the bottom 25% if there are fewer than 100 similar questions, or the bottom 50% if there are more than 100 similar questions. The method 60 then sorts the suggested question list 64 by influence score 12c, i.e. with the first question having the highest influence score and the last question have the lowest influence score.

In other embodiments, the logical aggregation method 60 may sort the suggested question list 64 using a combination of the influence score and similarity measure weighting.

After the suggested question list 64 is sorted using the similarity measures and influence scores the method 60 creates an argument list 66 having all of the argument objects 14 that the question objects 12 in the sorted question list 64 have been linked with, i.e. the argument objects 14 in the question objects list of argument objects 12B. The argument list 66 is then sorted by argument similarity measures 22C, with similar arguments, i.e. those having similarity measures above a predetermined level, being grouped together visually to avoid displaying repeated arguments to the user. For example, arguments that have been merged more than 10 times may be grouped together.

The method 60 returns a list of the most influential and most relevant arguments from sources that address the question that was searched from, including the associated evidence. Other factors may also be used to sort the list, including, for example, date of creation and/or amount of discussion surrounding an argument.

The results returned by logical aggregation 60 are in stark contrast to those returned by traditional online search results. Using any common search engine such as GOOGLE or BING a user may enter key words to search the internet. The results of the search are a long list of links to that contain at least somewhat relevant information. However, to process this information a user must click each link, read the content, mentally process the content, and find some way to retain the retain the content. Logical aggregation 60, on the other hand, returns the list of arguments that are directly relevant to the question, while also including the underlying evidence that supports the argument.

For example, using a common online search engine to search for the words “which smartphone should I buy” returns links to websites having such titles as: 1) Best smartphones 2017; 2) iPhone 7, Samsung Galaxy S7 or Google Pixel?; 3) 10 Best smartphones in the US; 4) 10 Best Android phones 016: whish should you buy? While these sites likely include information that is relevant to the question, the user is no closer to forming a decision and must engage in tedious process of clicking through each link, attempting to identify and extract useful information, and then process and retain that information.

Performing logical aggregation 60 within the interface 1000 on the same question causes a keyword search of the questions in the database 200, allows the user to select a relevant or interesting question for the list of questions returned from the keyword search, and returns the arguments that are found in similar questions, such as: 1) if you're already an Apple user, it's probably best to stick with the iPhone; 2) The Galaxy S7 has the best processing speed of any smartphone; 3) the iPhone 7 has an upgraded camera that is optimized for selfies; 4) the iPhone has fewer bugs and is more easily maintained.

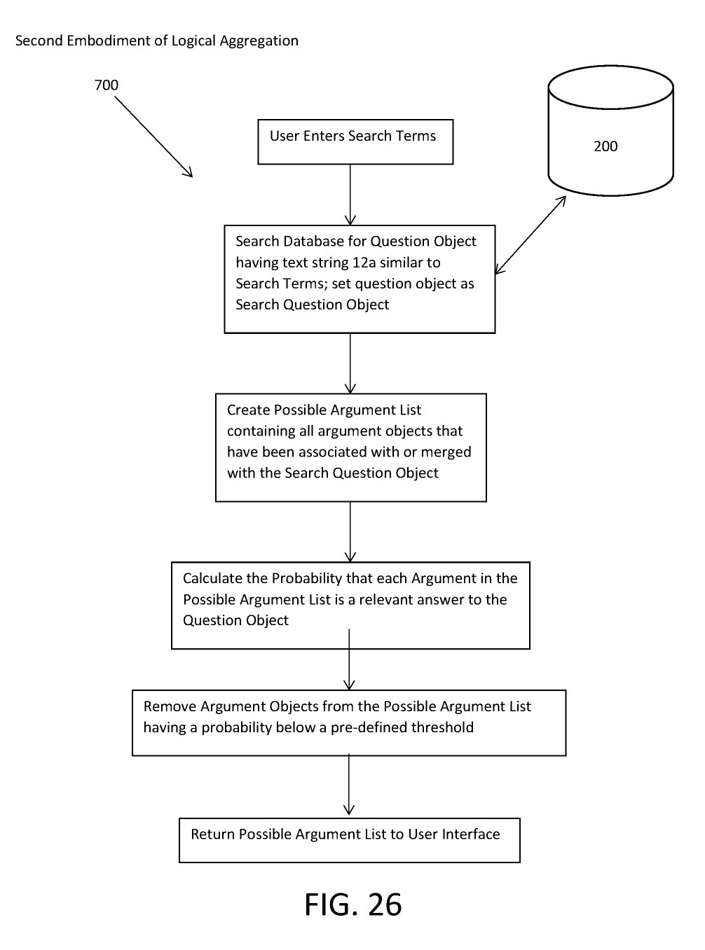

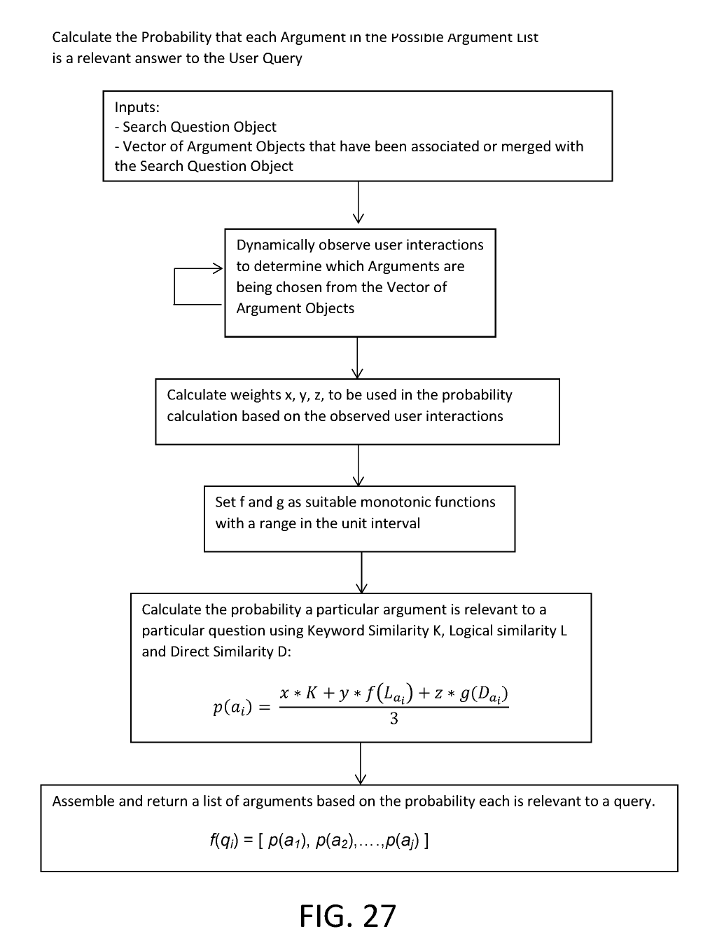

The third type of search is the second embodiment of logical aggregation 700, illustrated by FIGS. 26-27. As previously explained, the goal of logical aggregation is to determine the set of arguments 14 that are most logically relevant for a given question 12.

Assume that the database 200 is populated with a mature set of data, meaning that there are a number of question objects 12, argument objects 14, and questionargument objects 16 such that a number of users have created a number of question 12 and argument 14 associations. Upon entry of search terms the method 700 searches the question objects 12 in the database 200 and finds a similar question object 12 qᵢ. That question object 12 qᵢ has a list of QuestionArgument Objects 16 from which it may access all of the argument objects 14 that it, qᵢ, has previously been associated with.

For the given question 12 qᵢ in the set of all questions 12 Q, logical aggregation 700 produces a set of probabilities p(aⱼ) that each argument 14 aⱼ; that qᵢ has been associated with in the past and therefore was used to answer question qᵢ. The greater the probability, the more likely argument 14 aⱼ is used to answer qᵢ, and thus, the more likely that it is a good result to return for question 12 qᵢ.

Assume qᵢ is a question 12 in the total set of questions, aⱼ is an argument 14 in the total set of arguments previously associated with qᵢ, and n is the total number of arguments 14 associated with qᵢ. Thus, a vector of logically relevant arguments 14 generated by the logical aggregation method 700 for a given question qᵢ is the following:

f(qᵢ)=[p(a₁), p(a₂), . . . ,p(aₙ)]

where p(a₁) is the probability that argument 14 aⱼ is used to answer qᵢ, it is defined as follows:

$$p ( {a}_{j} ) = \frac{x * {Ka}_{i} + y * f ( {L}_{{a}_{i}} ) + z * g ( {D}_{{a}_{i}} )}{3}$$

Where: Kₐᵢ is the keyword similarity between qᵢ and aⱼ; Lₐᵢ is the logical similarity between qᵢ and a₁; Dₐᵢ is the direct similarity between qᵢ and aⱼ; x, y and z are the respective weights for each element; and f and g are suitably chosen monotonic functions with a range in the unit interval to normalize the similarity measure.

The results of the second embodiment of logical aggregation 700 are the arguments 14 that have previously been associated with the question 12 that have a probability over a predefined threshold, such as 0.3, ordered by probability from highest to lowest.

In order to generate the above model, the weights x, y and z need to be calculated. These weights do not have an inherent value, but rather may have any arbitrary value. To calculate the values of x, y and z such that the method 700 returns the best arguments 14 for any inputted question 12 the method 700 dynamically changes and improve the weight values over time based on user interactions, such that the error between the result of the method 700 and observed data is minimized.

In order to measure the error of the method 700, the results need to be compared to observed data generated by the users. This data is in the form of an n-dimensional vector (where n is the number of arguments), consisting of 1's and 0's, indicating whether or not a particular argument was used to answer a particular question for a given user. This data is collected from users merging arguments 14 into belief trees 30 over time. This data is used to train the method 700 so as to calculate the values x, y, and z such that the method 700 produces the best fit for the observed data. For a given user, each question 12 (qᵢ) has a vector of arguments 14 Aᵢ.

Aᵢ=[a₁, a₂, . . . , aₙ]

where aₙ denotes whether or not that user chose argument 14 aₙ to answer question 12 qᵢ, where 1 denotes that aₙ was used to answer qᵢ; and 0 denotes that it was not. For example, the following vector represents the arguments 14 (a₁ . . . aₙ) for question 12 qᵢ.

Aᵢ=[0, 1, 0, 0, 1, 1, 0, 0, 0, 0, 0, 0, 1, 0]

In the example above, the observed set of arguments 14 for question 12 qᵢ is a₂, a₅, a₆, and a₁₃.

In this notation, the subscript i refers to one instance of a question 12 sought by one user. Thus qᵢ and qⱼ may actually refer to the same question 12, but examined by two different users. It is very likely that Aᵢ≠Aⱼ, i.e. the users chose different arguments 14 for the same question 12.

Ultimately, across all users, questions 12 and arguments 14, what the method has is a collection of ordered pairs {(qᵢ, Aᵢ)} where qᵢ is a question 12 posed, and A is a list of arguments 14 to that question 12 chosen by a user.

In order to calculate the weights x, y and z, the method 700 sets the values x, y and z such that the mean squared error (MSE) between the result of the method and the observed data is minimized. MSE is the average squared difference between the estimated values and the observed values. MSE is a measure of the quality of the method 700, and if the MSE is minimized, the ability and quality of the method improves. The MSE function for a given question 12 qᵢ is defined below:

$$M S {E}_{{q}_{i}} = \frac{1}{n} {\sum }_{m = 1}^{n} {( {A}_{{i}_{m}} - )}^{2}$$

Where, n is the total number of arguments 14, Aᵢ is the observed data vector for question qᵢ; Â is the model predicted vector for question qᵢ which is obtained using the function f(qᵢ) defined above, and m is the index in each vector.

MSE_{qi} calculates the MSE for a given question qᵢ. In order to calculate the MSE for a given set of questions 12 Q, the average MSE across all questions in question set Q is calculated as follows:

$$M S {E}_{Q} = \frac{1}{k} {\sum }_{i = 1}^{k} M S {E}_{qi}$$

Where k is the total number of questions 12 in the set Q and MSE_{qi} is the mean squared error of the method 700 for a given question 14 qᵢ.

Once the observed data is obtained, the function MSE_{Q} is in terms of x, y, and z. In order to calculate the values x, y, and z that minimize the MSE, the partial derivative of MSE is taken in terms of x, y, and z. Taking the partial derivative of MSE in terms of x, y, and z, setting each equal to 0, and solving for x, y, or z yields the weight values that minimize the MSE of the model.

∇MSE(x, y, z)=0

The method then checks each set of potential x, y, and z values by plugging them back into the total MSE function MSEQ to determine which set yields the smallest MSE across the question set.

Once the weight values are calculated for the model, the methods uses the probability equation defined above to determine the logical relevance between a single argument and a given question qi. The method then uses this result to calculate the vector of logically relevant arguments, which are returned as the logical aggregation search results.

The weight values produced by this method are dynamically updated as more data is added to the system (i.e. users merge more arguments into belief trees), as this additional data helps to improve the method further. Argument Objects 14 having a predicted value of relevance p(aⱼ) over a predefined threshold, for example, above 0.7, are returned to the user as possible arguments 14 to address an entered question 12.

The fourth type of search and suggestion is the QA Suggestion method 70, illustrated in FIG. ZZ, which suggests Argument Objects 14 that may be influential to a user based on a question 12 or group of questions 12 that the user has considered, i.e. has created, saved or searched, etc. The QA Suggestion method 70 identifies a question or set of questions that a user is considering or has considered by searching the currently active user interface page 1000 for question objects 12, such as the question objects 12 that are found in a belief tree 30 or a question object that has been or is being constructed in an interface page 1000, and adds all such question objects 12 to a list of question objects 72.

The QA suggestion method 70 iterates through the list of question objects 72 and for each question object 12 in the list 72 the method 70 iterates through the question object's 12 merged question object list 12d and, if the linked question object 18b is not already in the list 72, it is added to a suggestion list 74.

The suggestion method 70 sorts the suggestion list 74 in the same manner as the logical aggregation search method 60. More specifically, the method 70 removes question objects from the suggestion list 74 having a similarity measure 18c that is below a cutoff level 76. The cutoff level 76 may be defined in a number of ways. For example, the cutoff level may be set to reject the lowest 25% of similar questions. Or, it may be set based on the number of similar questions, i.e. it may reject the bottom 25% if there are fewer than 100 similar questions, or the bottom 50% if there are more than 100 similar questions. The method 70 then sorts the list 74 by influence scores 12c, i.e. listing the question object 12 with the highest influence score 12c first, and returns the sorted list 74 to the user.

As previously mentioned, question objects 12 and argument objects 14 may be added to the data store 200 using either manual or automated methods. FIG. ZZ illustrates a manual method 500 of adding Question Objects 12 and Argument Objects 14 to the database 200. The user first identifies source material 26, which is, generally, a source of information that contains arguments and/or some evidence that appears pertinent to a topic of interest. The user may use source material 26 from any suitable medium, such as, for example, written articles, blog posts, video segments and/or audio clips. The source material 26 may be found on the internet, in which case it may be added in a number of conventional ways, such as, for example, through the use of cutting and pasting tools that are available on most computer and mobile device platforms or through manual data entry. The source material 26 may also come from sources outside of the internet and other digital mediums, such as printed materials or presentation at a lecture or during a conference, through the manual data entry.

The user uses the source material 26 to create a question 12 that presents the topic or idea that the source material 26 is addressing. The user adds an argument text string 14A, which may be a summary of the arguments the source material 26 is making or, if appropriate based on the context of the source material 26, it may be a direct quote from the source material 26. The user may also optionally add argument quotes 14B/14C by cutting and pasting pertinent passages directly from the source material 26. The question objects 12 and argument objects 14, may be entered in any order and the method 100 also allows the creation of questions without, or with empty, arguments or evidence.

For example, a user wishes to decide which smartphone is the best phone for a particular purpose, such as battery life or processing speed. While on a consumer review website the user finds an article that discusses the best smartphones, and particularly those that have the best battery life, and that includes a number of charts showing how long each phones battery lasts under a particular set of situations, i.e. sending emails or streaming video. In a separate browser window the user accesses the interface 1000 and then creates a question that summarizes the topic of the article, such as “which smart phone has the best battery life?”, and enters the text in a question dialog box. The user then adds a summary of the argument in an argument dialog box, such as “The Google Nexus has the best battery life of any smartphone, but the Galaxy S7 comes in a close second”, and then the user optionally attaches argument quotes by cutting and pasting the text from the article itself.

Users may also use the QA Structure creation process 500 without source material 26. With this option, rather than add the arguments 14 from source material 26, the user populates all of the fields based on his or her questions 12 and arguments 14. This allows the user to manually enter information from non-digital sources, and also allows the user to post questions and arguments that others may add arguments and/or evidence too. A user may also save Questions 12 and/or Arguments 14 that were created by other users in the user interface 1000 to his/her own user interface pages. Users may also merge two or more questions together, as further explained in the following paragraphs.

Alternatively, Argument Objects 14 may also be added to the database 200, and thereby be available to user in executing the method 100, through an automated method of scraping 300, which is illustrated in FIGS. ZZ & W. The first step in the scraping method 300 is to identify and summarize key points in content, e.g. articles, books, videos, etc., that are found on the internet or in other electronic formats such as portable document format (“PDF”). In that regard, the method 100 may run on the internet in order to automatically fill the data store 200 with a number useful argument objects 14, and separately an option may be provided to upload PDF documents to the interface 1000 using conventional means, after which the scraping method 300 may be run on the user-uploaded documents.

Generally, the scraping method 300 is focused on linking sentences from a citing work that makes a citation or reference to a source work. In this context, a citing work is a web page that is found/accessed by the method 300 or it is a work such as a PDF that is uploaded by the user, and the source work is a second work, i.e. a document, website, or reference of some type, which is referenced by the citing work. This summarization by adjacent document approach results in more reliable summaries than traditional summarization methods because it is a form of abstractive summarization—where the abstraction, i.e. a linking sentence, is typically carefully created by a human with expertise in the field relating to the source document. Documents that are particularly amenable to the scraping method 300 are those with a clear link or citation structure. For example, Hypertext Markup Language (“HTML”) web articles link to other web sources with a standardized <a> tag; and academic papers, industry reports, etc. follow standardized reference formats (e.g. bibliographies, inline citation, footnotes, endnotes).

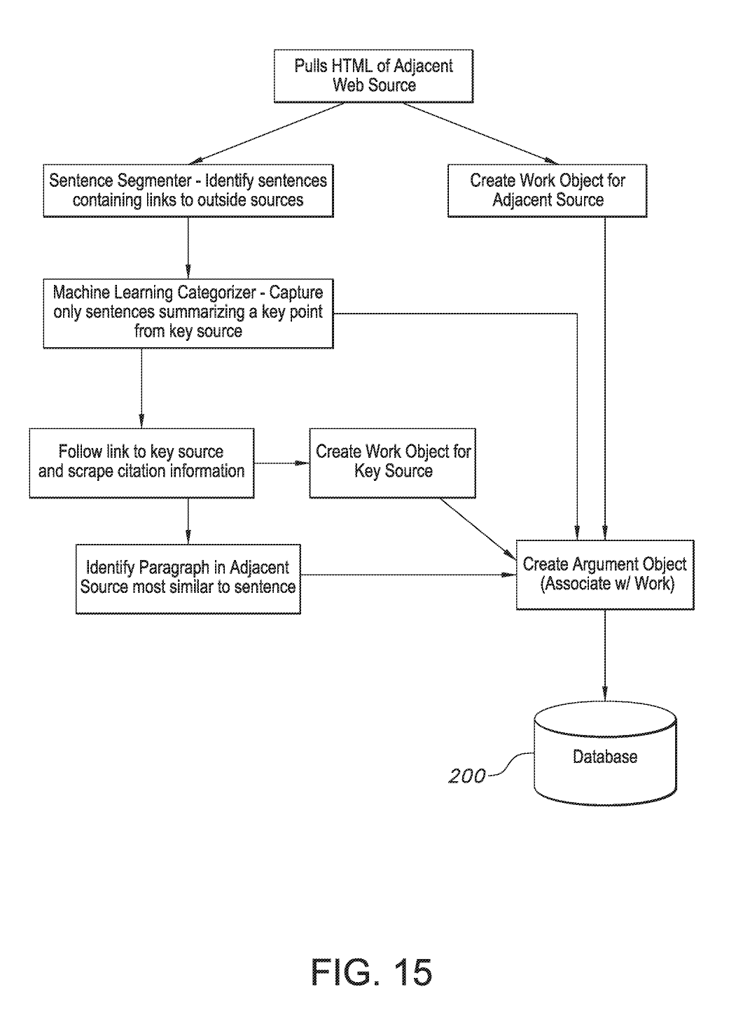

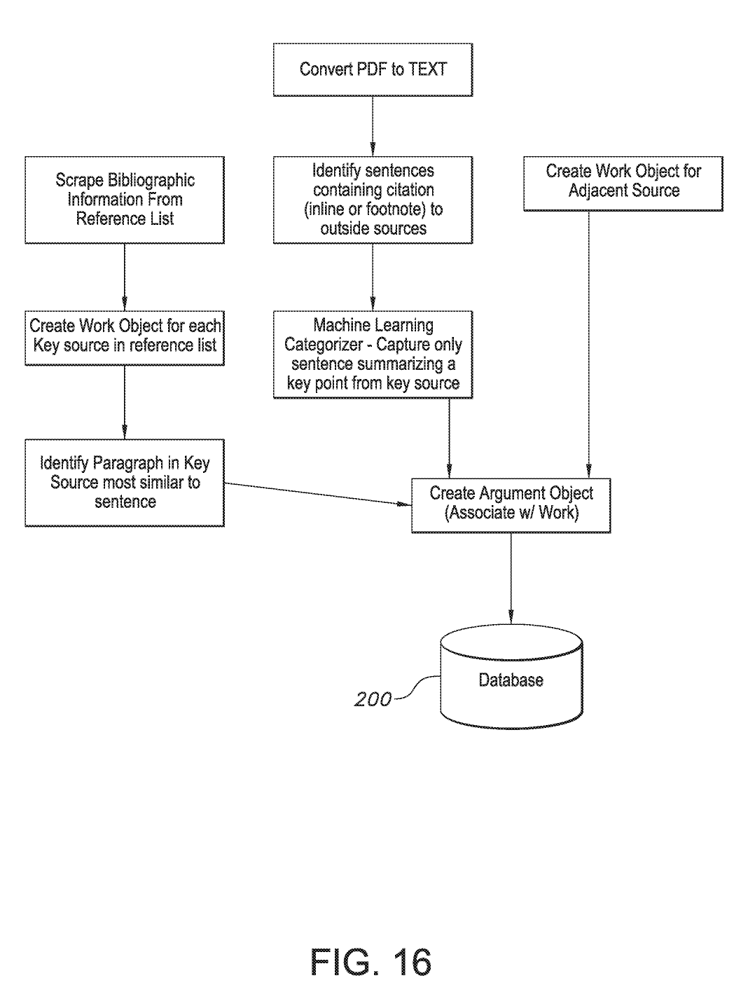

The first step in the scraping method 300 is to identify documents of interest. Again, the two primarily types of documents are web pages and PDFs. The method of extracting argument objects 14 from a web page is illustrated in FIG. 15 and the method of extracting argument objects 14 from a PDF is illustrated in FIG. 16. With web documents the scraping method 300 uses conventional web scraping or web crawling technologies to find web documents on the Internet such as, for example, aggregate RSS feeds from many sources to get web documents in real-time, receive input links from users, and scrape historical records of sources of interest by crawling publicly available documents. With PDF documents, users are able to upload links to publicly accessible PDF documents directly into the interface 1000, the interface using conventional technological means to upload PDF documents. The documents may also be found online using web searches or other conventional means for locating links to publicly accessible PDFs.

The second step in the scraping method 300 is to convert the document to parsable text. In the case of web documents, the method 300 takes the contents of the article by looking at all of the text within paragraph <p> tags. For PDF documents, the method uses conventional PDF-to-text conversion tools to turn PDFs into easily machine readable text files.

The third step in the scraping method 300 is to identify linking sentences and context sentences. A linking sentence is any sentence that makes a reference to an external source. For example, see the following paragraph from a Branding Strategy Insider article with the linking sentence in underlined: “New forms of search are also changing how we query what we need to know. Mary Meeker's most recent report on the state of the internet highlighted that as voice recognition accuracy improves, voice itself now constitutes 20% of mobile searches. We are shifting away from the written systems we have relied on in recent years to ways of finding what we want . . . .” Frequently, these sentences contain an anchor tag <a> in HTML documents, in which case the anchor tag is used to identify and extract the complete sentence using conventional sentence segmentation techniques. Linking sentences may also be identified by the type of language used, i.e. when they contain phrases like “according to X”, or “A report by Y found that”. Context sentences are the set of sentences prior to and after the linking sentence.

For PDF documents including but not limited to academic papers and official reports, linking sentences are those that contain a citation reference to another source. This is typically signified by inline citation notation, i.e., Author, Year, or a footnote. The method uses conventional sentence segmentation tools to break documents down into an array of sentences.

The fourth step in the scraping method 300 is to categorize sentences to identify which sentences contain valuable information. To identify valuable linking sentences for web documents, the method trains a natural language processing (“nlp”) machine learning model using a conventional machine learning library, such as the tensor flow library. To train the model, humans look for sentences that explicitly mention a study, report, research, finding, statistic and related words and phrases. Those sentences that make such a mention are labeled a 1 and those that do not are labeled a 0. Some examples of valuable referencing sentences include: “And by 2019, the voice recognition market is expected to be worth $601 million, according to a report from independent research firm TechNavio.”; “Studies have found that immigration has no effect on crime, and that crime has actually decreased despite the increasing immigrant population”; “Our rich society is full of people presenting happy smiling faces both in person and online, but when the Mental Health Foundation commissioned a large survey last year, it found that 74% of adults were so stressed they felt overwhelmed or unable to cope”; “In the history of the draft, which started in 1965, 21 players picked first have compiled at least 20 career wins above replacement, according to Baseball Reference”; “Though unemployment numbers have improved across the board, the same discrepancies persist: white Americans had an unemployment rate of only 4.5 percent at the close of 2016, but black workers had an unemployment rate of 7.9 percent.”

Linking sentences in PDF documents typically represent a valuable finding or statistic, and as such the method 300 does not need but may still use a similar a machine learning model to categorize valuable sentences. General the method follows the following rules: Remove sentence if any of these conditions is true, and keep the sentence if none are true: 1. Check if text starts with brackets, curly braces, parentheses; 2. Check if there are any large chunks of capital letters (minimum 5 characters to avoid weeding out acronyms); 3. Check for odd spacing from headers (ex. My normal T h i s i s a h e a d e r sentence); 4. Check if there are any question marks or exclamation points; 5. Check if there are links or urls present in the line; 6. Check to make sure the first letter is capitalized; 7. Check to ensure grammatical correctness (Optional); Check if there is a first person or ambiguous pronoun including but not limited to “I”, “We”, “Our”, “It” “These”, “Those”, “My”, “Mine”.

The fifth step in the scraping method 300 is to map linking sentences to reference information. In order to give proper credit to the information that the method scrapes, the method gathers as much citation information as possible and links back to the original document hosted on the server from which it was scraped.

The final step is to create an argument object 14 that contains the relevant information and save that object 14 to the data store 200. More specifically, the linking sentence is set as the argument object's text string 14A, the context sentence that precedes the linking sentence is set as the argument object's previous sentence 14B and the context sentence that following the linking sentence is set at the argument object's next sentence 14C. Two work objects 24 are populated with the information for the citing work and the source work, respectively. The work objects, shown in FIG. 5F, include all the contextual information of the work. The two work objects 24 are added to the argument objects 14 link to citing work object 14E and link to source work object 14F.

The argument object 14 and work objects 24 are then saved to the database 200, making all of the arguments 14 that are created by the scraping method 300 available to the interface, such that when a user enters a question 12 a list of potentially relevant arguments 14 is presented in the interface 1000, and the user may create QuestionArgument structures 16 by adding the selected argument 14 to the entered question 12, e.g. through the belief tree 30 creation process.

In general, it is likely the scraping method 300 is run for some time prior to a significant amount of user interaction as this populates the database 200 and provides more argument objects 14 for the user to consider in constructing belief trees 30.

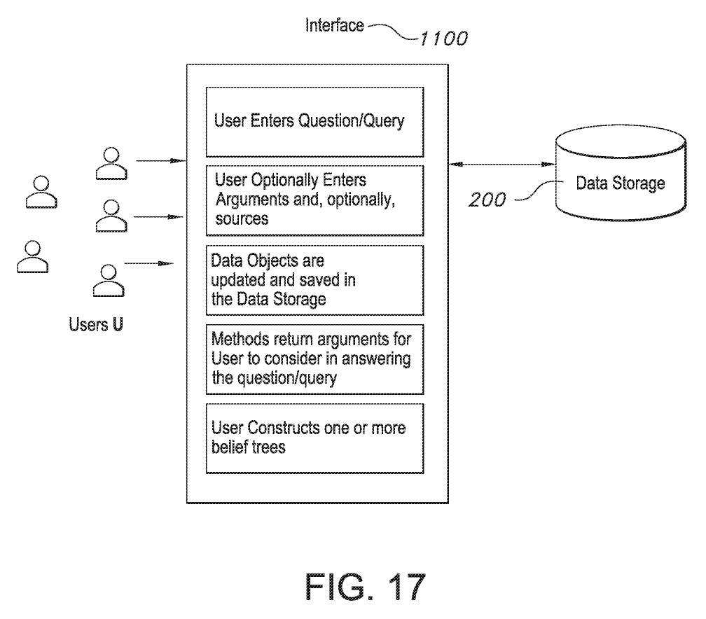

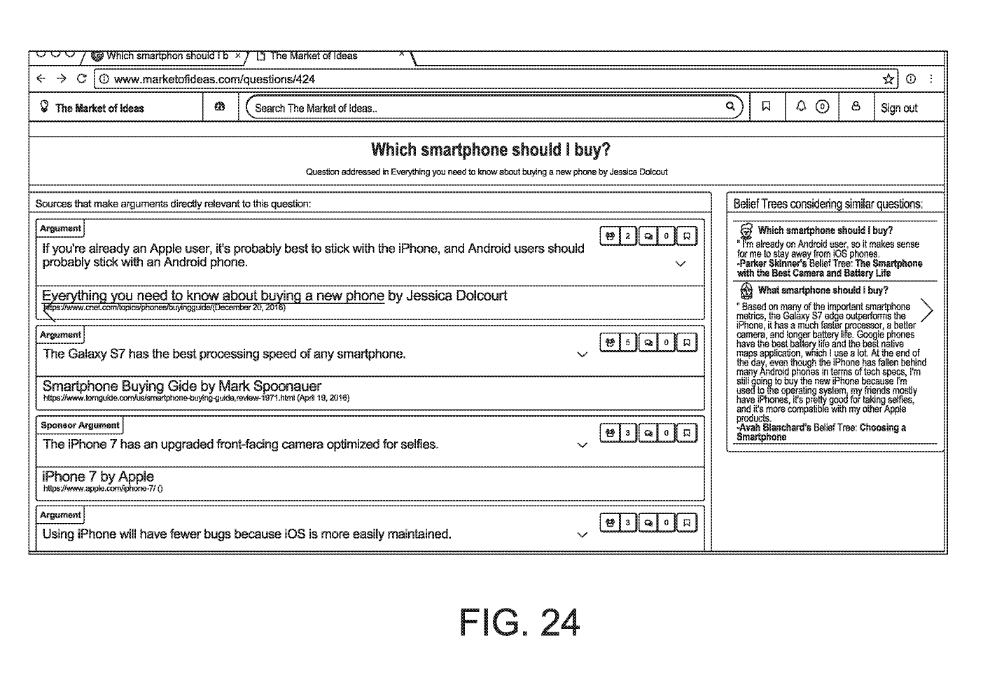

FIGS. 17-24 illustrate the first example of an interface 1000, which is a social networking system interface 1100. The social networking system interface 1100 allows users to collaboratively develop beliefs based on their own questions 12 and arguments 14, as well as those developed or suggested by other users in the network 1100, and the arguments that are gathered through the web scraping method 300.

For example, within the social networking system 1100 the users may manually enter and create questions 12 and find and enter arguments 14, and manually make the associations. Each user has a set of social networking system interface pages, also referred to as user interface pages 1110, that allow him or her to, among other activities, construct Questions 12 and add Arguments 14, build belief trees 30, perform a keyword search 50 of data stored in the data store 200, search for arguments that have been influential to other users through a logical aggregation search process 60, 700, view and consider question-argument (“QA”) suggestions 70, have a Socratic dialogue 80 with other users to mutually develop well-reasoned and better informed beliefs, and to view activity related to other users, i.e. the Arguments 14 that they are considering or the belief trees 30 that they are formulating, in an activity feed interface page 1120.

As previously explained, the questions 12 and arguments 14 are used to create the belief trees 30, which may include a belief summary 32, and one or more question 12 and argument 14 that support the belief summary 32. The belief summary 32 is a user created summary of a belief that is based on the underlying question objects 12 and argument objects 14. As users develop question objects 12, argument objects 14, and belief trees 30 the underlying data, i.e. the question, arguments, optionally evidence or source materials, are saved to a data store 200.

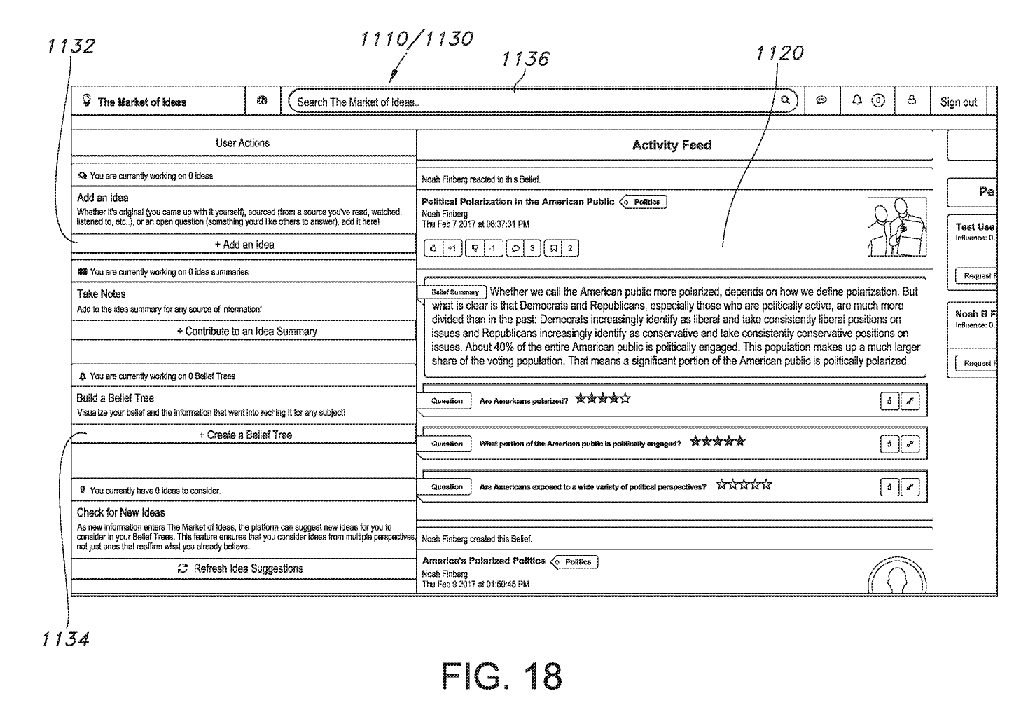

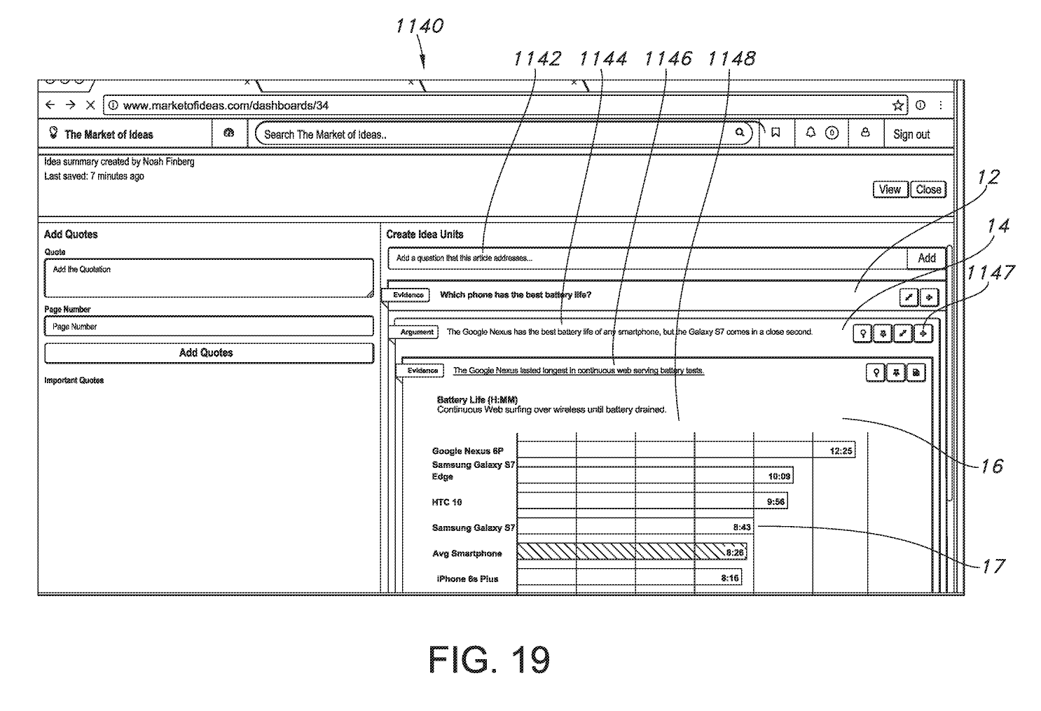

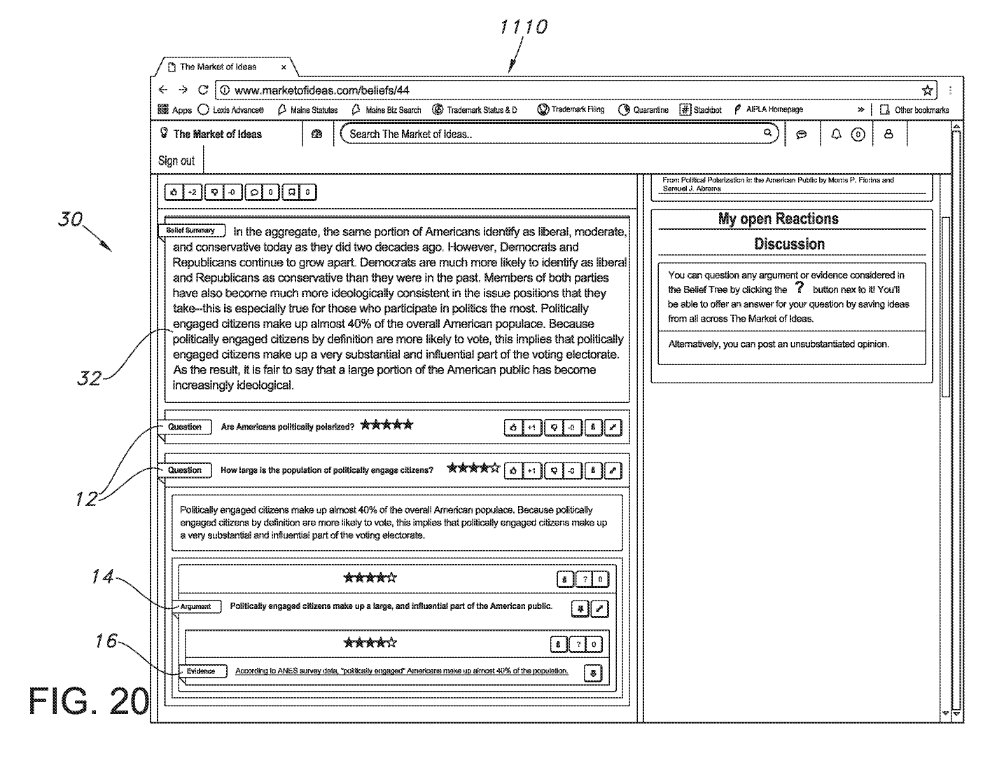

FIG. 18 is an example of a user home page 1130 having a question creation button 1132 for creating a question object 12, a belief tree creation button 1134 for creating a belief tree 30, and a search field 1136 for conducting a keyword search 50 or logical aggregation search 60, 700, of the data store 1190. The activity feed 1120 is also shown. Selecting the Question creation button 1132 takes the user to a Question creation interface page 1140, an example of which is illustrated in FIG. 19, which includes text entry boxes for entering questions 1142, argument summaries 1144, evidence summaries 1146, and options 1147, 1038 for attaching argument quotes 15 and evidence samples 17. A question 12, argument 14, and optional evidence summary 15 and evidence sample 17 are also shown. FIG. 20 is an example of a belief tree 30, showing the belief summary 32 and two questions 12, with one of the questions expanded to show the associated argument summary 14 and an optional evidence summary 15.

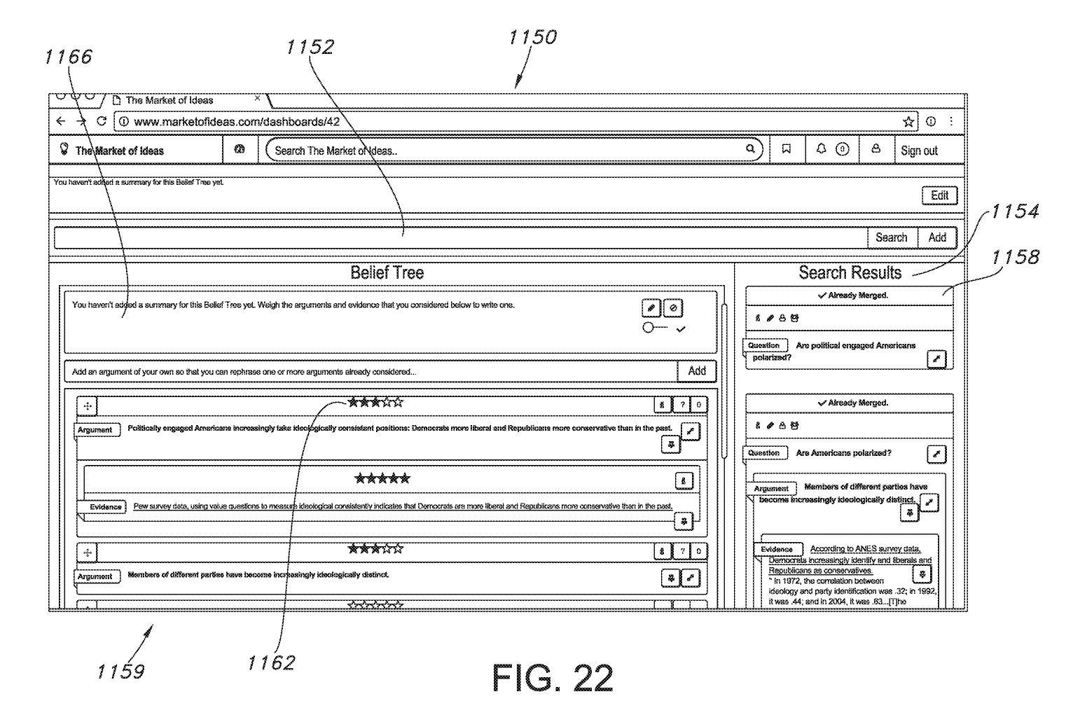

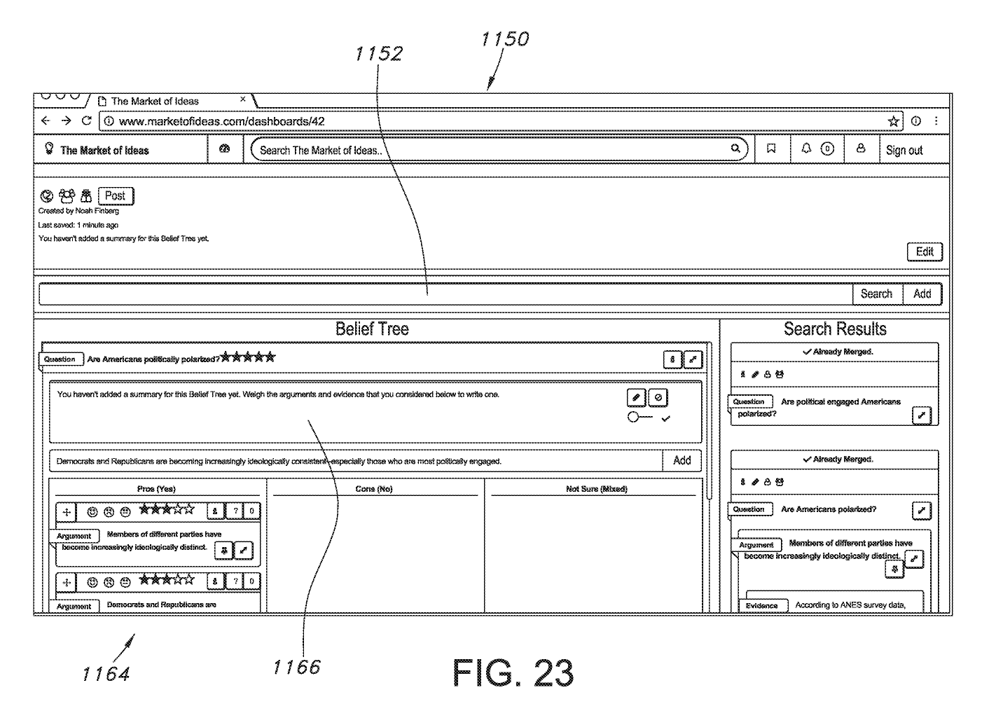

In general, not all argument objects 14 are equally relevant or equally persuasive, and the belief tree creation interface page 1150, shown in FIG. 22, allows the user to indicate a ranking option 1162 to add 1 to 5 stars to the argument object 14 to indicate how relevant he/she found the argument object 14 in the belief tree 30. FIG. 23 illustrates a pro/con table 1164 within the belief tree creation page 1050 that allows the user to visualize, categorize and organize the various question objects 12 and argument objects 14 to aide in his/her deliberation. Users may also type answers to individual questions. Once the user is satisfied that he/she has considered a sufficient number of questions he/she types or updates his/her belief summary 32 in to the belief creation dialog box by selecting the edit button 1167 and saves the belief tree 30. Saving a belief tree 30 publishes the belief tree 30 to the user's interface pages 1110 and saves the belief tree 30 objects, i.e. the question objects 22, argument objects 24 and evidence objects 26, to the data store 1190.

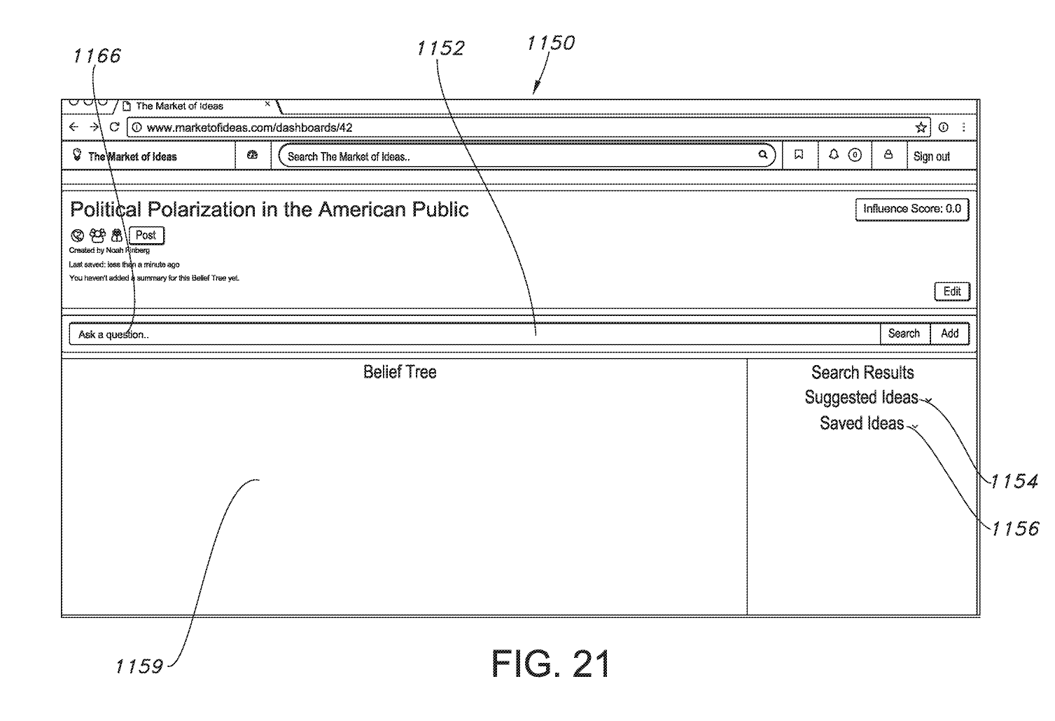

For example, from the home screen illustrated in FIG. 18 the user may initiate the belief tree creation process 30 by selecting the belief tree creation button 1134. Selecting the belief tree creation button 1134 causes a dialog window (not shown) to appear prompting the user to enter a title, such as “Political Polarization in American Politics”, and a topic, such as “Politics.” Entering the title and topic takes the user to the belief tree creation page 1150 illustrated by FIGS. 21-23. Once on the belief tree creation interface page 1150 the user may search for argument objects 14 by, for example, entering search terms in the search window 1166. This keyword search 50 returns search results in the search results window 1158.

Searching for the keywords “are Americans politically polarized?” may return a number of question objects 12 and argument objects 14, such as 1) Question: are Americans polarized?; Argument: Politically engaged Americans increasingly take ideologically consistent positions; evidence: quotes and charts from an article published by the Pew Research Centers; and 2) Question: Are Americans becoming more polarized?; Argument: members of different parties have become increasingly ideologically distinct; Evidence: ANES Survey Data.

The user considers each question 12 and the underlying arguments 14, and, after finding the question 12 and/or argument 14 persuasive or, at least, relevant, uses the merge button 1158 to add the objects associated with the question objects 12 and argument objects to the belief tree 30.

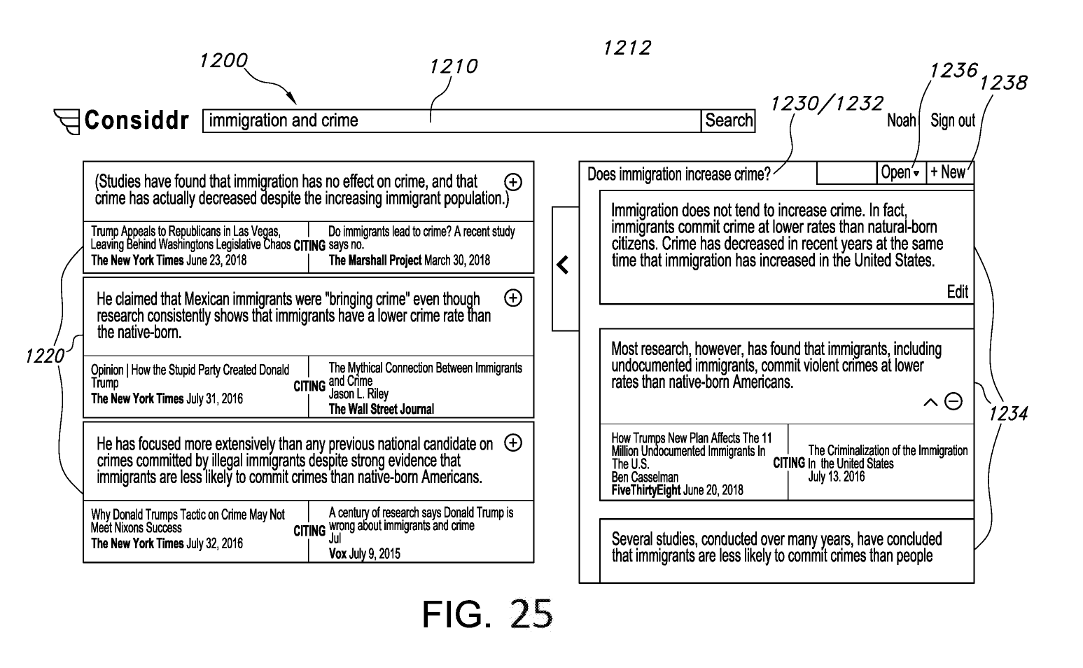

FIG. 25 illustrates the second embodiment of the interface 1000, which is in the form of a search engine 1200. The search engine 1200 includes a search window 1210 where user may enter questions, keywords, and/or phrases. Again, this description refers to the text entered into the search window as a “question”, however, it is understood that the text need not necessarily be in the form of a proper question and may simply be, for example, key words that are of interest to a user. Entering a question and hitting the “search” button 1212 causes one or more of the previously defined search methods to return search results to a search results window 1220.

The user is then able to consider the various data objects 10 presented in the search results window 1220, and, assuming one or more appear relevant, the user is able to hit an add button 1222, which adds the object 10 to a belief tree in a belief tree window 1230. The belief tree window 1230 presents a belief that is being considered 1232, includes the list of arguments currently supporting the belief in a belief tree arguments window 1234, and allows the user with options to open other belief trees 1236 or to create a new belief tree 1238.

In the embodiment shown, the system environment comprises one or more client devices D, the interface 1000, and a network 1300. Although only three client devices 20 are shown it is understood that thousands or more client devices D may be coupled to the interface 1000 via the network 1300.

The client devices D include one or more computing devices that are able to receive user input and transmit and receive data via the network 1300. The client device may be a conventional computer system having an operating system such as Microsoft Windows, Apple OS X, or a Linux distribution. The client device may also be a mobile device such as a smart-phone, tablet, or personal digital assistant. The client devices D are configured to communicate via the network 1300 and execute an application such a as web browser that allows a user of the client device D to interact with the social networking system 1000. The client device D may also interact with the social networking system 1000 through an application programming interface that operates on a native operating system such as iOS or DROID.

The network 1300 may use any number of standard communication technologies, such as, for example, Ethernet, 802.11, 3G and/or 4G, digital subscriber lines, etc. Similarly, the network 1300 may use any number of standard communication protocols, such as, for example, transmission control protocol/internet protocol (TCP/IP), simple mail transfer protocol (SMTP), file transfer protocol (FTP), and/or the hypertext transport protocol (HTTP). The data being exchanged over the network 1300 may be represented using known technologies, such as hypertext markup language (HTML), and/or the extensible markup language (XML). A webserver 1320 links the interface 1000 via the network 1300 to the client devices D, and provides the functionality for receiving and routing messages between the interface 1000 and the client devices D.

It is understood that the embodiments described herein are merely illustrative of the present invention. Some portions of this describe the invention in terms of algorithms and flowcharts. These types of descriptions and representations are commonly used by those skilled in the software and data processing arts to convey the substance of their work to others of similar skill, and are understood to be implemented by computer programs or equivalent electrical circuits or the like. The described methods and processes may be embodied in software, firmware, hardware, or any suitable combination thereof.

Variations in the construction of the method may be contemplated by one skilled in the art without limiting the intended scope of the invention herein disclosed and as defined by the following claims.

What is claimed is:

1: A computer-implemented method of data organization and data searching for use in constructing evidence-based beliefs, the method comprising the steps of:
providing a data store that contains a plurality of objects including question objects and argument objects, the question objects each containing a question text string and the argument objects each containing an argument text string;
providing a user interface that has a search window in which the user may enter search terms for searching the data store, a search results window that displays search results from the data store, and a belief tree creation window for forming one or more belief trees, the user interface enabling access to the data store and having an option to allow the merger of one or more objects from the search results window to the one or more belief trees;
in response to receiving an entry of search terms in the search window, searching the data store for objects that are relevant to the search terms and returning a list of relevant objects in the search results window;
in response to receiving a request to merge one or more objects from the search results window into the belief tree, merging the one or more objects into the belief tree.

2: The computer-implemented method of claim 1, wherein the step of receiving an entry of search terms in the search window includes the step of searching the data store for question objects that have similar search terms and upon finding a question object having similar search terms using that question object as the search question object with this entry of search terms and upon finding no such question object creating a search question object that is a new question object for this entry of search terms; and
wherein the request to merge one or more objects from the search results window into the belief tree is a request to merge an argument object into the belief tree, and wherein merging an argument object into the belief tree includes the following:
associating the search question object with the argument object and creating a set of associated relevance scores;
merging the argument object into the belief tree;
saving the search question object and argument object association and associated relevance scores to the data store.

3: The computer-implemented method of claim 2, wherein the relevance scores includes a keyword relevance score and a direct relevance score;
wherein the keyword relevance score measures the similarity between the search question object text string and the argument object text string; and
wherein the direct relevance score measures the number of times the search question object and the argument object have been linked together in a belief tree.

4: The computer-implemented method of claim 3, wherein the relevance scores include a logical relevance score and wherein the question objects include a list of merged question objects, each merged question object containing links to a first question object and a second question object that have been merged together; and
wherein the logical relevance score is equal to the number of times the search question object has been merged with an argument object that has been merged with another question object in the search question objects merged question list.

5: The computer-implemented method of claim 4, wherein each merged question object includes a logical similarity score, and wherein the logical relevance score is equal to the sum of the merged question objects logical similarity scores for each merged question object that includes a question object that has been merged with an argument object that has also been merged with the search question object.

6: The computer-implemented method of claim 4, wherein each merged question objects logical similarity score is equal to 1 minus the Kullback-Leibler Divergence of the probability distribution of the merged question objects first question and the probability distribution of the merged question objects second question object.

7: The computer-implemented method of claim 4, the method including the following steps:
performing a keyword search of the data store question objects using the search terms and adding the data store question objects from the keyword search to a similar question list, the similar question list displayed in the user interface;
receiving from the user a selected question object from the similar question list;
in response to receiving the selected question object, adding all question objects that the selected question object has been merged with to a suggested question list;
sorting the suggested question list;
displaying the suggested question list in the interface.

8: The computer-implemented method of claim 4, the method including the following steps:
accessing an associated arguments list of argument objects that have been associated with the search question object;
for each argument in the associated arguments list, calculate the probability that it answers the search terms by adding the keyword relevance score multiplied by a weighting measure to the logical relevance score normalized by a monotonic function with a range in the unit interval multiplied by a weight and to the direct relevance measure normalized by a monotonic function with a range in the unit interval and multiplied by a weight and dividing the sum by three;
removing all arguments from the associated argument list that have a probability below a defined threshold, and returning the associated arguments to the user.

9: A computer-implemented method of identifying argument suggestions from a database in response to an entry of search terms in an interface, the database containing one or more question objects and one or more argument objects, the computer-implemented method comprising the steps of:
performing a keyword search of the database question objects and adding the data store question objects from the keyword search to a similar question list, the similar question list displayed in the user interface;
receiving from the user a selected question object from the similar question list;
in response to receiving the selected question object, adding all question objects that the selected question object has been merged with to a suggested question list;
sorting the suggested question list;
displaying the suggested question list in the interface.

10: The computer-implemented method of claim 9, wherein the question objects in the database have a similarity measure and a influence score, and wherein sorting the suggested question list includes the steps of:
removing all question objects having a similarity measure below a cutoff level from the suggested question list;
sorting the suggested question list by influence score.

11: The computer-implemented method of claim 10, wherein the argument objects associated with the question objects in the suggested question list are displayed to the user in the interface.

12: The computer-implemented method of claim 11, wherein each argument object has a set of merged argument objects, and wherein each merged argument object has a first merged argument object, a second merged argument object, and a similarity measure, and wherein the argument objects associated with the question objects in the suggested question list are grouped by the merged argument object's similarity measure.

13: A computer-implemented method of summarization by adjacent document, the method comprising the steps of:
Identifying one or more citing sentences in the electronic work that contains one or more links to source work;
create an argument object for each of the one or more citing sentences, each argument object having a text string, wherein each of the one or more citing sentences is set as the argument object text string for one of the argument objects;
save the one or more argument objects in a data store.

14: The computer-implemented of claim 13, wherein the electronic work is an hypertext markup language document and the step of identifying one or more citing sentences in the electronic work includes the following:
Identifying text within the hypertext markup language document;
Searching the text for citing sentences that contain one or more links or references to a source work.

15: The computer-implemented of claim 13, wherein the electronic work is a portable document format document and the step of identifying one or more citing sentences in the electronic work includes the following:
Converting the portable document format to text;
Searching the text for citing sentences that contain one or more links or references to source work.

16: The computer-implemented of claim 13, wherein the step of identifying one or more citing sentences in the electronic work includes the following steps:
using a machine learning categorizer to identify citing sentences in the electronic work.

17: A computer-implemented method of finding logically relevant argument objects in response to entry of search terms into a user interface by one or more users, the logically relevant argument objects stored in a data store, the data store containing question objects and argument objects, some question objects being associated with some argument objects, the question objects and argument objects having a set of relevance measures including a keyword relevance measure, a logical relevance measures, and a direct relevance measures that are stored in the data store, the method comprising the steps of:
searching the data store for the search terms and finding a search question object that is a question object having a text string that is similar to the search terms;
creating an associated arguments list of argument objects that have been associated with the search question object;
creating a set of weights for weighting the set of relevance measures, the set of weights including a keyword weight, a logical weight, and a direct weight;
applying the set of weights to the relevance measures to create a weighted keyword relevance measure, a weighted logical relevance measure and a weighted direct relevance measure;
for each argument in the associated arguments list, calculate the probability that it answers the search terms by adding the weighted keyword relevance score to the weighted logical relevance score to the weighted direct relevance measure and dividing the sum by three;
removing all argument objects from the associated argument list that have a probability below a defined threshold, and returning the associated argument lists to the user interface.

18: The computer implemented method of claim 17, wherein the step of creating a set of weights includes the steps of:
gathering a vector of observed data in the form of an n-dimensional vector generated from users' searching questions and merging arguments into one or more belief trees;
calculating the mean squared error between the vector of observed data and a model predicted vector for the search question object;
taking the partial derivative of the aggregate mean squared error function with respect to each of the weights in the set of weights;
selecting the set of weights that result in the smallest mean squared error value.

19: The computer implemented method of claim 18, wherein the step of calculating the probability that each argument answers the search terms includes the following:
for each argument in the associated arguments list, calculate the probability that it answers the search terms by adding the keyword relevance score multiplied by the keyword weight to the logical relevance score normalized by a monotonic function with a range in the unit interval multiplied by the logical weight and to the direct relevance measure normalized by a monotonic function with a range in the unit interval and multiplied by the direct weight and dividing the sum by three.
